(19) United States
(12) Patent Application Publication
(10) Pub. No.: US 2024/0176844 A1
(43) Pub. Date: May 30, 2024

(54) COMPUTER-READABLE RECORDING MEDIUM STORING INFORMATION PROCESSING PROGRAM, INFORMATION PROCESSING METHOD, AND INFORMATION PROCESSING APPARATUS

(71) Applicant: Fujitsu Limited, Kawasaki-shi (JP)

(72) Inventor: Takashi KATOH, Kawasaki (JP)

(73) Assignee: Fujitsu Limited, Kawasaki-shi (JP)

(21) Appl. No.: 18/370,992

(22) Filed: Sep. 21, 2023

(30) Foreign Application Priority Data
Nov. 29, 2022 (JP) 2022-189897

(51) Int. Cl. G06F 17/16

(52) U.S. Cl. CPC G06F 17/16

(57) ABSTRACT

A computer stores first matrix data that holds data of components of an array in a row direction, stores second matrix data that holds a flag that indicates whether the data is in an initialized state, and stores third matrix data that includes an area that holds an initial value common to a plurality of pieces of data in the column which is regarded as an initial value of each piece of data in the column in a case where a plurality of pieces of data in the column is collectively initialized in a column direction. Responding to a first initialization request for collectively initializing a plurality of pieces of data in a first column of the first matrix data in a column direction, a value that indicates an initialized state is set to a plurality of flags of the second matrix data.

### CROSS-REFERENCE TO RELATED APPLICATION

This application is based upon and claims the benefit of priority of the prior Japanese Patent Application No. 2022-189897, filed on Nov. 29, 2022, the entire contents of which are incorporated herein by reference.

### FIELD

The embodiment discussed herein is related to a computer-readable recording medium storing an information processing program, an information processing method, and an information processing apparatus.

### BACKGROUND

Heretofore, there has been matrix data that holds data of components of each array of a plurality of arrays in the row direction. There is a case where it is desired to collectively initialize a plurality of pieces of data in any row of the matrix data in the row direction, collectively initialize a plurality of pieces of data in any column of the matrix data in the column direction, or the like.

As related art, for example, there is a technique of controlling an array configured by connecting a plurality of blocks, the array having a boundary at a position where the number of unwritten blocks in a first area obtained by dividing the plurality of blocks into two and the number of written blocks in a second area obtained by dividing the plurality of blocks into two are in an integer ratio.

Japanese Laid-open Patent Publication No. 2018-037010 is disclosed as related art.

### SUMMARY

According to an aspect of the embodiments, a computer-readable recording medium storing an information processing program for causing a computer to execute a process including: storing, in a storage, first matrix data that holds data of components of an array in a row direction; storing, in the storage, second matrix data that holds, in association with each piece of data in the first matrix data, a flag that indicates whether the data is in an initialized state in which data is collectively initialized in a column direction; storing, in the storage, third matrix data that includes an area that holds, in association with each column of the first matrix data, an initial value common to a plurality of pieces of data in the column which is regarded as an initial value of each piece of data in the column in a case where a plurality of pieces of data in the column is collectively initialized in a column direction; in response to reception of a first initialization request for collectively initializing a plurality of pieces of data in a first column of the first matrix data in a column direction, setting a value that indicates an initialized state to a plurality of flags of the second matrix data respectively associated with a plurality of pieces of data in the first column; and in response to reception of the first initialization request, setting a first initial value in any area of the third matrix data associated with the first column.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an exemplary embodiment of an information processing method according to an embodiment;

FIG. 2 is an explanatory diagram illustrating an example of an information processing system;

FIG. 3 is a block diagram illustrating an example of a hardware configuration of an information processing apparatus;

FIG. 4 is a block diagram illustrating an example of a functional configuration of the information processing apparatus;

FIG. 5 is an explanatory diagram illustrating an example of the storage contents of the information processing apparatus;

FIG. 6 is an explanatory diagram illustrating an example of the data structure of payload matrix data (part 1);

FIG. 7 is an explanatory diagram illustrating an example of the data structure of payload matrix data (part 2);

FIG. 8 is an explanatory diagram illustrating an example of the data structure of order management matrix data (part 1);

FIG. 9 is an explanatory diagram illustrating an example of the data structure of order management matrix data (part 2);

FIG. 10 is an explanatory diagram illustrating an example of the data structure of order management matrix data (part 3);

FIG. 11 is an explanatory diagram illustrating an example of the data structure of order management matrix data (part 4);

FIG. 12 is an explanatory diagram illustrating an example of the data structure of order management matrix data (part 5);

FIG. 13 is an explanatory diagram illustrating an example of initializing the entire payload matrix data;

FIG. 14 is an explanatory diagram illustrating an example of initializing a row of the payload matrix data;

FIG. 15 is an explanatory diagram illustrating an example of initializing a column of the payload matrix data;

FIG. 16 is an explanatory diagram illustrating an example of reading data of a component of an array;

FIG. 17 is an explanatory diagram illustrating an example of writing data of a component of an array;

FIG. 18 is an explanatory diagram illustrating an example of application of the information processing apparatus;

FIG. 19 is an explanatory diagram illustrating an example of the effect produced by the information processing apparatus;

FIG. 20 is a flowchart illustrating an example of a procedure of entire initialization processing;

FIG. 21 is a flowchart illustrating an example of a procedure of row initialization processing;

FIG. 22 is a flowchart illustrating an example of a procedure of column initialization processing;

FIG. 23 is a flowchart illustrating an example of a procedure of read processing; and

FIG. 24 is a flowchart illustrating an example of a procedure of write processing.

### DESCRIPTION OF EMBODIMENTS

In the related art, it is difficult to collectively initialize a plurality of pieces of data in any column of matrix data in the column direction. For example, when a plurality of pieces of data in any column of matrix data is collectively initialized in the column direction, time corresponding to the length of the column is taken.

According to one aspect, an object of the present disclosure is to make it easier to collectively initialize a plurality of pieces of data in any column of matrix data in the column direction.

Hereinafter, an embodiment of an information processing program, an information processing method, and an information processing apparatus according to the present disclosure will be described in detail with reference to the drawings.

### (Exemplary Embodiment of Information Processing Method According to Embodiment)

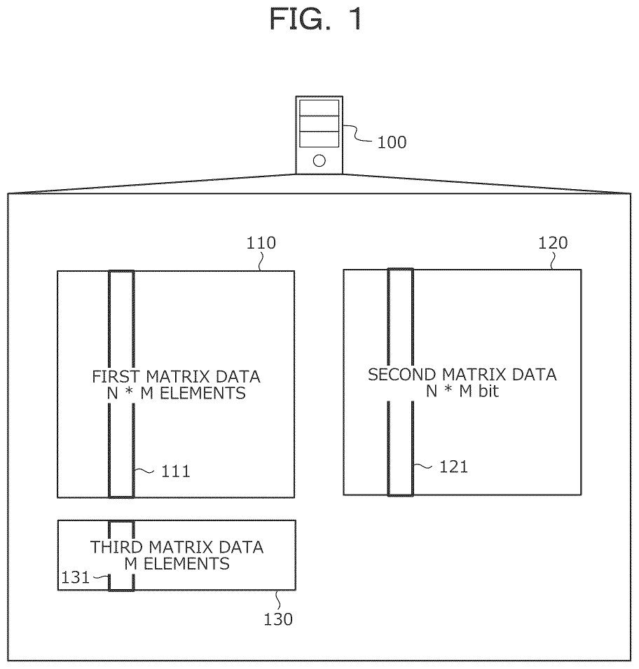

FIG. 1 is an explanatory diagram illustrating an exemplary embodiment of the information processing method according to the embodiment. An information processing apparatus 100 is a computer for managing matrix data. For example, the information processing apparatus 100 is a server, a personal computer (PC), or the like.

For example, matrix data holds data of components of each array of a plurality of arrays in the row direction. A plurality of rows of matrix data represents different arrays. For example, data of components of an array is considered to be data used for real-time transactions, online games, automatic driving, security measures, or the like. For example, data of a component of an array is a value. From the viewpoint of using data of components of an array, various queries may be received, and processing corresponding to the received various queries may be performed on matrix data.

For example, a query may be a write request that requests writing of data of a component of an array to matrix data. For example, a query may be a read request that requests reading of data of a component of an array from matrix data. For example, a query may be a row initialization request that requests collective initialization of a plurality of pieces of data in any row of matrix data in the row direction. For example, a query may be a column initialization request that requests collective initialization of a plurality of pieces of data in any column of matrix data in the column direction. For example, a query may be an entire initialization request that requests collective initialization of the entire matrix data.

There is a case where it is desired to achieve reduction of the processing load and processing time taken when processing corresponding to various queries is performed on matrix data. For example, there is a case where, when processing corresponding to various queries is performed on matrix data for real-time transactions, it is desired to ensure a certain or higher speed of response to the various queries.

However, in related art, there is a case where it is difficult to reduce the processing load and processing time taken when processing corresponding to a query is performed on matrix data to a certain level or less.

For example, a method is conceivable in which each row of matrix data is treated as a normal data structure. For example, the normal data structure is a data structure that directly includes only data of components of each array of a plurality of arrays. For example, the normal data structure does not include management data for collectively initializing a plurality of pieces of data in any of row of matrix data in the row direction.

According to this method, it is difficult to reduce the processing load and processing time taken when processing corresponding to a query is performed on matrix data to a certain level or less.

For example, the processing load and processing time taken when a plurality of pieces of data in any row of matrix data is collectively initialized in the row direction in response to a row initialization request are O (MN). O (⋅) is an order. M is the number of arrays. N is the number of components of an array. Accordingly, as the number of arrays increases, the processing load and processing time taken when a plurality of pieces of data in any row of matrix data is collectively initialized in the row direction increase.

For example, the processing load and processing time taken when a plurality of pieces of data in any column of matrix data is collectively initialized in the column direction in response to a column initialization request are O (MN). Accordingly, as the number of arrays increases and as the number of components of an array increases, the processing load and processing time taken when a plurality of pieces of data in any column of matrix data is collectively initialized in the column direction increase.

For example, the processing load and processing time taken when the entire matrix data is collectively initialized in response to an entire initialization request are O (MN). Accordingly, as the number of arrays increases and as the number of components of an array increases, the processing load and processing time taken when the entire matrix data is collectively initialized increase.

For example, a method is conceivable in which each row of matrix data is treated as a special data structure called optimal space initializable array. In the following description, there are cases where optimal space initializable array is referred to as “OSIA”. For example, Japanese Laid-open Patent Publication No. 2018-037010 described above may be referred to for the special data structure called OSIA.

Even with this method, it is difficult to reduce the processing load and processing time taken when processing corresponding to various queries is performed on matrix data to a certain level or less.

For example, the processing load and processing time taken when a plurality of pieces of data in any column of matrix data is collectively initialized in the column direction in response to a column initialization request are O (M). M is the number of arrays. Accordingly, as the number of arrays increases, the processing load and processing time taken when a plurality of pieces of data in any column of matrix data is collectively initialized in the column direction increase.

For example, the processing load and processing time taken when the entire matrix data is collectively initialized in response to an entire initialization request are O (M). Accordingly, as the number of arrays increases, the processing load and processing time taken when the entire matrix data is collectively initialized increase.

Accordingly, in the present embodiment, description will be given for the information processing method that may make it easier to collectively initialize a plurality of pieces of data in any column of matrix data in the column direction.

In FIG. 1, the information processing apparatus 100 stores first matrix data 110. For example, the storage destination is a storage unit of the information processing apparatus 100. For example, the first matrix data 110 includes an area group in a matrix shape of M rows and N columns, and holds data in each area. For example, M corresponds to the number of arrays. For example, N corresponds to the number of components of an array. For example, the first matrix data 110 holds data of components of an array in the row direction. For example, each row of the first matrix data 110 holds data of components of an array different from the other arrays.

The information processing apparatus 100 stores second matrix data 120. For example, the storage destination is the storage unit of the information processing apparatus 100. For example, the second matrix data 120 includes an area group in a matrix shape of M rows and N columns, and holds a flag in each area. For example, the second matrix data 120 holds, in association with each piece of data in the first matrix data 110, a flag indicating whether the data is in an initialized state in which data is collectively initialized in the column direction. For example, when the value of a flag is 0, the flag indicates that the data is in the initialized state. For example, when the value of a flag is 1, the flag indicates that the data is not in the initialized state. For example, the second matrix data 120 holds a flag indicating whether the data of the i-th row and j-th column of the first matrix data 110 is in the initialized state in which data is collectively initialized in the column direction, as the data of the i-th row and j-th column of the second matrix data 120.

The information processing apparatus 100 stores third matrix data 130. For example, the storage destination is the storage unit of the information processing apparatus 100. For example, the third matrix data 130 includes an area group of one row and N columns, and holds an initial value in each area. For example, the third matrix data 130 includes an area group of one row and N columns that holds, in association with each column of the first matrix data 110, an initial value common to a plurality of pieces of data in the column which is regarded as the initial value of each piece of data in the column in a case where the plurality of pieces of data in the column is collectively initialized in the column direction. For example, the third matrix data 130 holds, as the data in the j-th column of the third matrix data 130, an initial value common to a plurality of pieces of data in the j-th column of the first matrix data 110 in a case where the plurality of pieces of data in the j-th column is collectively initialized in the column direction.

(1-1) The information processing apparatus 100 receives a first initialization request for collectively initializing a plurality of pieces of data in a first column 111 of the first matrix data 110 in the column direction. For example, the first initialization request includes a column number as an index of the first column 111. For example, the first initialization request includes a first initial value as an initial value of the plurality of pieces of data in the first column 111.

(1-2) In response to the reception of the first initialization request, the information processing apparatus 100 sets a value indicating the initialized state for a plurality of flags of the second matrix data 120 respectively associated with the plurality of pieces of data in the first column 111. For example, the information processing apparatus 100 sets the value=0 indicating the initialized state for the plurality of flags in a second column 121 of the second matrix data 120 corresponding to the first column 111. For example, the second column 121 corresponding to the first column 111 is any column of the second matrix data 120 having the same column number as that of the first column 111. Accordingly, the information processing apparatus 100 may enable determination of initialization of the plurality of pieces of data in the first column 111.

(1-3) In response to the reception of the first initialization request, the information processing apparatus 100 sets the first initial value in any area 131 of the third matrix data 130 associated with the first column 111. For example, the area 131 corresponding to the first column 111 is an area of any column of the third matrix data 130 having the same column number as that of the first column 111.

Accordingly, the information processing apparatus 100 may collectively initialize the plurality of pieces of data in the first column 111 of the first matrix data 110 in the column direction without rewriting the plurality of pieces of data in the first column 111 of the first matrix data 110 themselves. For this reason, the information processing apparatus 100 may enable appropriate processing of a column initialization request that requests collective initialization of the plurality of pieces of data in the first column 111 of the first matrix data 110 in the column direction. The information processing apparatus 100 may reduce the processing load and processing time taken when the plurality of pieces of data in the first column 111 of the first matrix data 110 is collectively initialized in the column direction to O (1).

The information processing apparatus 100 may subsequently enable determination of the fact that any piece of data in the first column 111 is in the initialized state based on any flag in the second column 121 of the second matrix data 120 corresponding to the data. When any piece of data in the first column 111 is in the initialized state, the information processing apparatus 100 may read the any piece of data in the first column 111 by reading the first initial value in the area 131 as the any piece of data in the first column 111. For this reason, the information processing apparatus 100 may enable appropriate processing of a read request that requests reading of any piece of data in the first column 111.

The information processing apparatus 100 may subsequently enable management by the second matrix data 120 of the fact that any piece of data in the first column 111 is no longer in the initialized state when an arbitrary value is written to the any piece of data. For this reason, the information processing apparatus 100 may enable appropriate processing of a write request that requests writing of an arbitrary value to any piece of data in the first column 111.

Although a case has been described in which the information processing apparatus 100 is capable of collectively initializing a plurality of pieces of data in any column of the first matrix data 110 in the column direction, the embodiment is not limited to this case. There may be a case where the information processing apparatus 100 is capable of collectively initializing a plurality of pieces of data in any row of the first matrix data 110 in the row direction.

Although a case has been described in which the information processing apparatus 100 operates alone, the embodiment is not limited to this case. For example, there may be a case where the information processing apparatus 100 is in cooperation with another computer. For example, there may be a case where the information processing apparatus 100 controls another computer that stores the first matrix data 110, the second matrix data 120, and the third matrix data 130. For example, there may be a case where a plurality of computers implements the function of the information processing apparatus 100 in cooperation with each other. For example, there may be a case where the function of the information processing apparatus 100 is implemented on a cloud.

### (Example of Information Processing System 200)

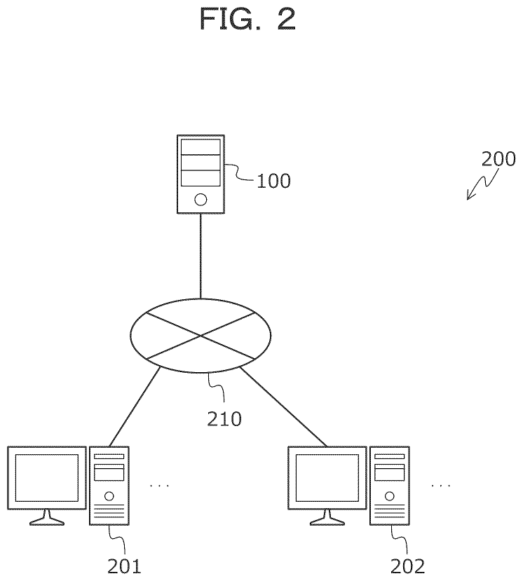

Next, an example of an information processing system 200 in which the information processing apparatus 100 illustrated in FIG. 1 is applied will be described with reference to FIG. 2.

FIG. 2 is an explanatory diagram illustrating an example of the information processing system 200. In FIG. 2, the information processing system 200 includes the information processing apparatus 100, an information accumulation apparatus 201, and a client apparatus 202.

In the information processing system 200, the information processing apparatus 100 and the information accumulation apparatus 201 are coupled to each other via a wired or wireless network 210. For example, the network 210 is a local area network (LAN), a wide area network (WAN), the Internet, or the like. In the information processing system 200, the information processing apparatus 100 and the client apparatus 202 are coupled to each other via the wired or wireless network 210.

The information accumulation apparatus 201 is a computer for storing various types of matrix data. For example, the information accumulation apparatus 201 stores first matrix data. For example, the first matrix data includes an area group in a matrix shape of M rows and N columns, and holds data in each area. For example, M corresponds to the number of arrays. For example, N corresponds to the number of components of an array. For example, the first matrix data holds data of components of an array in the row direction. For example, each row of the first matrix data holds data of components of an array different from the other arrays. For example, each row of the first matrix data is a block string in which blocks including a predetermined number of areas each of which may store data of a component of an array are connected. For example, a block string has the data structure called OSIA.

For example, the information accumulation apparatus 201 stores second matrix data. For example, the second matrix data includes an area group in a matrix shape of M rows and N columns, and holds a flag in each area. For example, the second matrix data holds, in association with each piece of data in the first matrix data, a flag indicating whether the data is in the initialized state in which data is collectively initialized in the column direction. For example, when the value of a flag is 0, the flag indicates that the data is in the initialized state. For example, when the value of a flag is 1, the flag indicates that the data is not in the initialized state. For example, the second matrix data holds a flag indicating whether the data of the i-th row and j-th column of the first matrix data is in the initialized state in which data is collectively initialized in the column direction, as the data of the i-th row and j-th column of the second matrix data.

For example, the information accumulation apparatus 201 stores third matrix data. For example, the third matrix data includes an area group of one row and N columns, and holds an initial value in each area. For example, the third matrix data includes an area group of one row and N columns that holds, in association with each column of the first matrix data, an initial value common to a plurality of pieces of data in the column which is regarded as the initial value of each piece of data in the column in a case where the plurality of pieces of data in the column is collectively initialized in the column direction. For example, the third matrix data holds, as the data in the j-th column of the third matrix data, an initial value common to a plurality of pieces of data in the j-th column of the first matrix data in a case where the plurality of pieces of data in the j-th column is collectively initialized in the column direction.

For example, the information accumulation apparatus 201 stores fourth matrix data. For example, the fourth matrix data includes an area group of one row and N+M columns, and holds a value giving the number of order to each row and each column of the first matrix data in each area. For example, the fourth matrix data holds, in association with each row of the first matrix data, a value indicating the number of order in which the row is collectively initialized among the rows and columns of the first matrix data. For example, the fourth matrix data holds, in association with each column of the first matrix data, a value indicating the number of order in which the column is collectively initialized among the rows and columns of the first matrix data. For example, the fourth matrix data holds, in the area of the i-th column of the fourth matrix data, a value indicating the number of order in which the i-th row of the first matrix data is collectively initialized. i=1 to M. For example, the fourth matrix data holds, in the area of the (M+j)-th column of the fourth matrix data, a value indicating the number of order in which the j-th column of the first matrix data is collectively initialized. j=1 to N.

For example, the information accumulation apparatus 201 is used by a system administrator who manages the information processing system 200. For example, the information accumulation apparatus 201 updates or uses various types of matrix data in accordance with the control of the information processing apparatus 100. For example, the information accumulation apparatus 201 writes data of a component of an array to the first matrix data in accordance with the control of the information processing apparatus 100. For example, the information accumulation apparatus 201 reads data of a component of an array from the first matrix data in accordance with the control of the information processing apparatus 100.

For example, the information accumulation apparatus 201 initializes a plurality of pieces of data in any row of the first matrix data in accordance with the control of the information processing apparatus 100. For example, the information accumulation apparatus 201 initializes a plurality of pieces of data in any column of the first matrix data in accordance with the control of the information processing apparatus 100. For example, the information accumulation apparatus 201 initializes the entire first matrix data in accordance with the control of the information processing apparatus 100. For example, the information accumulation apparatus 201 is a server, a PC, or the like.

The information processing apparatus 100 is a computer for controlling the information accumulation apparatus 201. For example, the information processing apparatus 100 is used by the system administrator who manages the information processing system 200.

The information processing apparatus 100 acquires a query. For example, the information processing apparatus 100 acquires a query by receiving the query from the client apparatus 202. For example, the information processing apparatus 100 may acquire a query by receiving input of the query based on the input operation of the system administrator. For example, a query may be a write request that requests writing of data of a component of an array to the first matrix data. For example, a query may be a read request that requests reading of data of a component of an array from the first matrix data.

For example, a query may be a row initialization request that requests collective initialization of a plurality of pieces of data in any row of the first matrix data in the row direction. For example, a query may be a column initialization request that requests collective initialization of a plurality of pieces of data in any column of the first matrix data in the column direction. For example, a query may be an entire initialization request that requests collective initialization of the entire first matrix data. The information processing apparatus 100 controls various types of matrix data by controlling the information accumulation apparatus 201 according to a query. For example, the information processing apparatus 100 is a server, a PC, or the like.

The client apparatus 202 is a computer used by a system user who uses the information processing system 200. The client apparatus 202 generates a query such as a write request, a read request, a row initialization request, a column initialization request, or an entire initialization request based on the input operation of the system user, and transmits the query to the information processing apparatus 100. For example, the client apparatus 202 is a PC, a tablet terminal, a smartphone, or the like.

Although a case has been described in which the information processing apparatus 100 is an apparatus different from the information accumulation apparatus 201, the embodiment is not limited to this case. For example, there may be a case where the information processing apparatus 100 has the function as the information accumulation apparatus 201 and also operates as the information accumulation apparatus 201. Although a case has been described in which the information processing apparatus 100 is an apparatus different from the client apparatus 202, the embodiment is not limited to this case. For example, there may be a case where the information processing apparatus 100 has the function as the client apparatus 202 and also operates as the client apparatus 202.

### (Example of Hardware Configuration of Information Processing Apparatus 100)

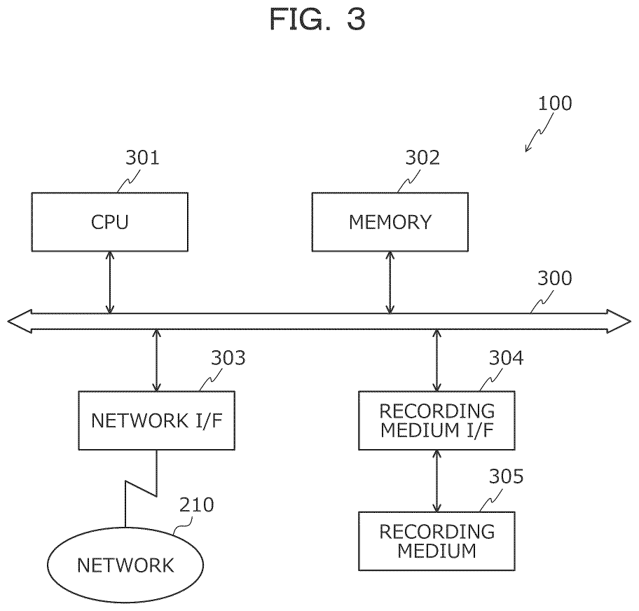

Next, an example of a hardware configuration of the information processing apparatus 100 will be described with reference to FIG. 3.

FIG. 3 is a block diagram illustrating an example of a hardware configuration of the information processing apparatus 100. In FIG. 3, the information processing apparatus 100 includes a central processing unit (CPU) 301, a memory 302, a network interface (I/F) 303, a recording medium I/F 304, and a recording medium 305. These components are coupled to one another through a bus 300.

The CPU 301 controls the entire information processing apparatus 100. For example, the memory 302 includes a read-only memory (ROM), a random-access memory (RAM), a flash ROM, and the like. For example, the flash ROM or the ROM stores various programs, and the RAM is used as a work area for the CPU 301. The programs stored in the memory 302 are loaded into the CPU 301, thereby causing the CPU 301 to execute the coded processing.

The network I/F 303 is coupled to the network 210 through a communication line, and is coupled to another computer via the network 210. The network I/F 303 serves as an interface between the network 210 and the internal components, and controls input and output of data from and to the other computer. For example, the network I/F 303 is a modem, a LAN adapter, or the like.

The recording medium I/F 304 controls reading and writing of data from and to the recording medium 305 in accordance with the control of the CPU 301. For example, the recording medium I/F 304 is a disk drive, a solid-state drive (SSD), a Universal Serial Bus (USB) port, or the like. The recording medium 305 is a nonvolatile memory that stores data written under the control of the recording medium I/F 304. For example, the recording medium 305 is a disk, a semiconductor memory, a USB memory, or the like. The recording medium 305 may be removably attached to the information processing apparatus 100.

In addition to the components described above, for example, the information processing apparatus 100 may include a keyboard, a mouse, a display, a printer, a scanner, a microphone, a speaker, and the like. The information processing apparatus 100 may include a plurality of recording medium I/Fs 304 and a plurality of recording media 305. The information processing apparatus 100 does not have to include the recording medium I/F 304 and the recording medium 305.

### (Example of Hardware Configuration of Information Accumulation Apparatus 201)

For example, an example of a hardware configuration of the information accumulation apparatus 201 is similar to the example of a hardware configuration of the information processing apparatus 100 illustrated in FIG. 3, and thus description thereof will be omitted.

### (Example of Hardware Configuration of Client Apparatus 202)

For example, an example of a hardware configuration of the client apparatus 202 is similar to the example of a hardware configuration of the information processing apparatus 100 illustrated in FIG. 3, and thus description thereof will be omitted.

### (Example of Functional Configuration of Information Processing Apparatus 100)

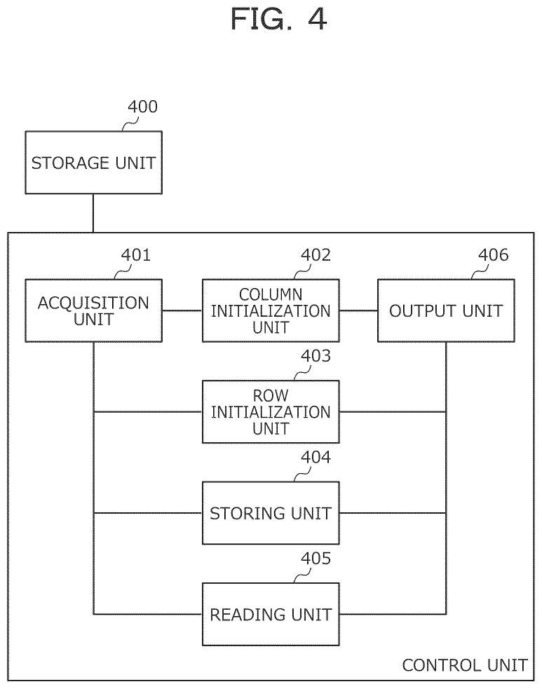

Next, an example of a functional configuration of the information processing apparatus 100 will be described with reference to FIG. 4.

FIG. 4 is a block diagram illustrating an example of a functional configuration of the information processing apparatus 100. The information processing apparatus 100 includes a storage unit 400, an acquisition unit 401, a column initialization unit 402, a row initialization unit 403, a storing unit 404, a reading unit 405, and an output unit 406.

For example, the storage unit 400 is realized by a storage area such as the memory 302 or the recording medium 305 illustrated in FIG. 3. Although a case will be described below in which the storage unit 400 is included in the information processing apparatus 100, the embodiment is not limited to this case. For example, there may be a case where the storage unit 400 is included in an apparatus different from the information processing apparatus 100 and the information processing apparatus 100 is allowed to refer to the storage contents of the storage unit 400.

The acquisition unit 401 to the output unit 406 function as an example of a control unit. For example, the functions of the acquisition unit 401 to the output unit 406 are implemented by causing the CPU 301 to execute a program stored in the storage area such as the memory 302 or the recording medium 305 illustrated in FIG. 3, or by using the network I/F 303. For example, a processing result of each functional unit is stored in the storage area such as the memory 302 or the recording medium 305 illustrated in FIG. 3.

The storage unit 400 stores various types of information to be referred to or updated in the processing of each functional unit. For example, the storage unit 400 stores the first matrix data. For example, the first matrix data includes an area for holding data of components of an array. For example, the first matrix data includes a plurality of areas in a matrix shape of M rows and N columns each of which may store data of a component of an array. For example, M corresponds to the number of arrays. For example, N corresponds to the number of components of an array. For example, the first matrix data holds data of components of an array in the row direction.

For example, the first matrix data may be capable of holding, in association with each row of the first matrix data, in a predetermined area of the row, an initial value common to a plurality of pieces of data in the row which is regarded as the initial value of each piece of data in the row in a case where the plurality of pieces of data in the row is collectively initialized in the row direction. For example, each row of the first matrix data is a block string in which blocks including a predetermined number of areas each of which may store data of a component of an array are connected. For example, each row of the first matrix data is considered to have the special data structure called OSIA in the row direction.

For example, the storage unit 400 stores the second matrix data. For example, the second matrix data includes an area that holds, in association with each piece of data in the first matrix data, a flag indicating whether the data is in the initialized state in which data is collectively initialized in the column direction. For example, when the value of a flag is 0, the flag indicates that the data is in the initialized state. For example, when the value of a flag is 1, the flag indicates that the data is not in the initialized state. For example, the second matrix data includes an area group in a matrix shape of M rows and N columns, and holds a flag in each area.

For example, the second matrix data holds a flag indicating whether the data of the i-th row and j-th column of the first matrix data is in the initialized state in which data is collectively initialized in the column direction, as the data of the i-th row and j-th column of the second matrix data. For example, each column of the second matrix data is considered to have the special data structure called OSIA in the column direction.

For example, the storage unit 400 stores the third matrix data. For example, the third matrix data includes an area that holds, in association with each column of the first matrix data, an initial value common to a plurality of pieces of data in the column which is regarded as the initial value of each piece of data in the column in a case where the plurality of pieces of data in the column is collectively initialized in the column direction. For example, the third matrix data includes an area group of one row and N columns, and holds an initial value in each area. For example, the third matrix data holds, as the data in the j-th column of the third matrix data, an initial value common to a plurality of pieces of data in the j-th column of the first matrix data in a case where the plurality of pieces of data in the j-th column is collectively initialized in the column direction.

For example, the storage unit 400 stores the fourth matrix data. For example, the fourth matrix data indicates an order relationship in which each row of the first matrix data is collectively initialized and each column of the first matrix data is collectively initialized. For example, the fourth matrix data indicates at least an order relationship in which the first column of the first matrix data is collectively initialized and the first row of the first matrix data is collectively initialized. For example, the fourth matrix data includes an area group of one row and N+M columns, and holds a value giving the number of order to each row and each column of the first matrix data in each area.

For example, the fourth matrix data holds, in association with each row of the first matrix data, a value indicating the number of order in which the row is collectively initialized among the rows and columns of the first matrix data. For example, the fourth matrix data holds, in association with each column of the first matrix data, a value indicating the number of order in which the column is collectively initialized among the rows and columns of the first matrix data. A value indicating the number of order in which the i-th row of the first matrix data is collectively initialized is held in the area of the i-th column of the fourth matrix data. i=1 to M. A value indicating the number of order in which the j-th column of the first matrix data is collectively initialized is held in the area of the (M+j)-th column of the fourth matrix data. j=1 to N.

The acquisition unit 401 acquires various types of information to be used in the processing of each functional unit. The acquisition unit 401 stores the acquired various types of information in the storage unit 400 or outputs the information to each functional unit. The acquisition unit 401 may output the various types of information stored in the storage unit 400 to each functional unit. For example, the acquisition unit 401 acquires various types of information based on the input operation of a user. For example, the acquisition unit 401 may receive various types of information from an apparatus different from the information processing apparatus 100.

For example, the acquisition unit 401 acquires a query. For example, the acquisition unit 401 acquires a query by receiving the query from another computer. For example, the other computer is the client apparatus 202 or the like. For example, the acquisition unit 401 may acquire a query by receiving input of the query based on the input operation of a user.

For example, a query may be a write request that requests writing of data of a component of an array to the first matrix data. For example, a query may be a read request that requests reading of data of a component of an array from the first matrix data.

For example, a query may be a row initialization request that requests collective initialization of a plurality of pieces of data in any row of the first matrix data in the row direction. For example, a query may be a column initialization request that requests collective initialization of a plurality of pieces of data in any column of the first matrix data in the column direction. For example, a query may be an entire initialization request that requests collective initialization of the entire first matrix data.

For example, the acquisition unit 401 receives a first initialization request that requests collective initialization of a plurality of pieces of data in the first column of the first matrix data in the column direction. For example, the first initialization request includes information that enables identification of the first column. For example, the first initialization request includes the column number of the first column as the information that enables identification of the first column.

For example, the acquisition unit 401 receives a second initialization request that requests collective initialization of a plurality of pieces of data in the first row of the first matrix data in the row direction. For example, the second initialization request includes information that enables identification of the first row. For example, the second initialization request includes the row number of the first row as the information that enables identification of the first row.

For example, the acquisition unit 401 receives an entire initialization request that requests initialization of the entire first matrix data.

For example, the acquisition unit 401 receives a write request that requests writing of a designated value to the data at the intersection of the first column and the first row in the first matrix data. For example, the write request includes information that enables identification of the first column and the first row. For example, the write request includes a combination of the column number of the first column and the row number of the first row as the information that enables identification of the first column and the first row. For example, the write request includes the designated value.

For example, the acquisition unit 401 receives a read request that requests reading of the data at the intersection of the first column and the first row in the first matrix data. For example, the read request includes information that enables identification of the first column and the first row. For example, the read request includes a combination of the column number of the first column and the row number of the first row as the information that enables identification of the first column and the first row.

The acquisition unit 401 may receive a start trigger for starting the processing of any functional unit. For example, the start trigger is a predetermined input operation of a user. For example, the start trigger may be reception of predetermined information from another computer. For example, the start trigger may be output of predetermined information from any functional unit.

The acquisition unit 401 may receive the reception of the first initialization request as the start trigger for starting the processing of the column initialization unit 402. The acquisition unit 401 may receive the reception of the second initialization request as the start trigger for starting the processing of the row initialization unit 403. The acquisition unit 401 may receive the reception of the entire initialization request as the start trigger for starting the processing of the column initialization unit 402 and the row initialization unit 403. The acquisition unit 401 may receive the reception of the write request as the start trigger for starting the processing of the storing unit 404. The acquisition unit 401 may receive the reception of the read request as the start trigger for starting the processing of the reading unit 405.

In response to the reception of the first initialization request, the column initialization unit 402 sets a value indicating the initialized state for a plurality of flags of the second matrix data respectively associated with the plurality of pieces of data in the first column. In response to the reception of the first initialization request, the column initialization unit 402 sets a first initial value in any area of the third matrix data associated with the first column.

Accordingly, the column initialization unit 402 may collectively initialize the plurality of pieces of data in the first column in the column direction. If each column of the second matrix data has the special data structure called OSIA, the column initialization unit 402 may reduce the processing load and processing time taken when the plurality of pieces of data in the first column is collectively initialized in the column direction to O (1). The column initialization unit 402 may enable the reading unit 405 to read the first initial value as any piece of data in the first column.

In response to the reception of the first initialization request, the column initialization unit 402 updates the fourth matrix data such that the first column is at the top of the order among the rows and columns of the first matrix data. Accordingly, the column initialization unit 402 may enable determination of the number of order in which each row and each column of the first matrix data is initialized. For this reason, the column initialization unit 402 may obtain a guideline for appropriately reading the data at the intersection of the first column and the first row from the first matrix data. For example, the column initialization unit 402 may enable appropriate determination of whether it is preferable that the reading unit 405 reads the first initial value as the data at the intersection of the first column and the first row.

In response to the reception of the second initialization request, the row initialization unit 403 sets a second initial value in a predetermined area of the first row. For example, the predetermined area is an unused area in the last block of the first row where the value of a component is not yet stored. In response to the reception of the second initialization request, the row initialization unit 403 may set the second initial value in a predetermined area that is associated with the first row and not included in the first row.

Accordingly, the row initialization unit 403 may collectively initialize the plurality of pieces of data in the first row in the row direction. If each row of the first matrix data has the special data structure called OSIA, the row initialization unit 403 may reduce the processing load and processing time taken when the plurality of pieces of data in the first row is collectively initialized in the row direction to O (1). The row initialization unit 403 may enable the reading unit 405 to read the second initial value as any piece of data in the first row.

In response to the reception of the second initialization request, the row initialization unit 403 updates the fourth matrix data such that the first row is at the top of the order among the rows and columns of the first matrix data. Accordingly, the row initialization unit 403 may enable determination of the number of order in which each row and each column of the first matrix data is initialized. For this reason, the row initialization unit 403 may obtain a guideline for appropriately reading the data at the intersection of the first column and the first row from the first matrix data. For example, the row initialization unit 403 may enable appropriate determination of whether it is preferable that the reading unit 405 reads the second initial value as the data at the intersection of the first column and the first row.

In response to the reception of the write request that requests writing of the designated value to the data at the intersection of the first column and the first row in the first matrix data, the storing unit 404 updates the first matrix data such that the data at the intersection indicates the designated value. In response to the reception of the write request that requests writing of the designated value to the data at the intersection of the first column and the first row, the storing unit 404 sets a value indicating that the data is not in the initialized state for any flag of the second matrix data associated with the data at the intersection.

Accordingly, the storing unit 404 may write the designated value to the data at the intersection of the first column and the first row in the first matrix data. The storing unit 404 may reduce the processing load and processing time taken when the designated value is written to the data at the intersection of the first column and the first row in the first matrix data to O (1).

The storing unit 404 may manage that the data at the intersection of the first column and the first row in the first matrix data is no longer in the initialized state based on the second matrix data. For this reason, the storing unit 404 may enable appropriate determination of whether it is preferable that the reading unit 405 reads the data at the intersection of the first column and the first row itself.

In response to the reception of the read request that requests reading of the data at the intersection of the first column and the first row in the first matrix data, the reading unit 405 determines whether the first initial value and the second initial value have been set. When the first initial value has been set and the second initial value has been set, the reading unit 405 refers to the fourth matrix data and determines whether the number of order of the first column is closer to the top side compared to that of the first row.

When the number of order of the first column is closer to the top side compared to that of the first row, the reading unit 405 reads the first initial value as the data at the intersection of the first column and the first row. When the number of order of the first column is not closer to the top side compared to that of the first row and the number of order of the first row is closer to the top side compared to that of the first column, the reading unit 405 reads the second initial value as the data at the intersection of the first column and the first row.

When the first initial value has been set and the second initial value has not been set, the reading unit 405 reads the first initial value as the data at the intersection of the first column and the first row. When the first initial value has not been set and the second initial value has been set, the reading unit 405 reads the second initial value as the data at the intersection of the first column and the first row. When the first initial value has not been set and the second initial value has not been set, the reading unit 405 reads the data at the intersection of the first column and the first row in the first matrix data itself.

Accordingly, the reading unit 405 may appropriately read the value being the data at the intersection of the first column and the first row. The reading unit 405 may reduce the processing load and processing time taken when the value being the data at the intersection of the first column and the first row is read to O (1).

The output unit 406 outputs a processing result of at least any functional unit. For example, the form of output is display on a display, output to a printer for printing, transmission to an external apparatus through the network I/F 303, or storage in the storage area such as the memory 302 or the recording medium 305. Accordingly, the output unit 406 may enable a user to be notified of a processing result of at least any functional unit, and achieve improvement in the convenience of the information processing apparatus 100.

For example, in response to the first initialization request that requests collective initialization of a plurality of pieces of data in the first column of the first matrix data in the column direction, the output unit 406 outputs a first response indicating that the plurality of pieces of data in the first column has been successfully collectively initialized in the column direction. For example, the output unit 406 outputs the first response so that a user may refer to the first response. Accordingly, the output unit 406 may enable a user to know that the plurality of pieces of data in the first column has been successfully collectively initialized in the column direction.

For example, in response to the second initialization request that requests collective initialization of a plurality of pieces of data in the first row of the first matrix data in the row direction, the output unit 406 outputs a second response indicating that the plurality of pieces of data in the first row has been successfully collectively initialized in the row direction. For example, the output unit 406 outputs the second response so that a user may refer to the second response. Accordingly, the output unit 406 may enable a user to know that the plurality of pieces of data in the first row has been successfully collectively initialized in the row direction.

For example, in response to the entire initialization request that requests initialization of the entire first matrix data, the output unit 406 outputs a third response indicating that the entire first matrix data has been successfully initialized. For example, the output unit 406 outputs the third response so that a user may refer to the third response. Accordingly, the output unit 406 may enable a user to know that the entire first matrix data has been successfully initialized.

For example, in response to the write request that requests writing of the designated value to the data at the intersection of the first column and the first row in the first matrix data, the output unit 406 outputs a fourth response indicating that the designated value has been successfully written to the data at the intersection of the first column and the first row. For example, the output unit 406 outputs the fourth response so that a user may refer to the fourth response. Accordingly, the output unit 406 may enable a user to know that the designated value has been successfully written to the data at the intersection of the first column and the first row.

For example, in response to the read request that requests reading of the data at the intersection of the first column and the first row in the first matrix data, the output unit 406 outputs the read data at the intersection of the first column and the first row. For example, the output unit 406 outputs the data at the intersection of the first column and the first row so that a user may refer to the data. Accordingly, the output unit 406 may enable the use of the data at the intersection of the first column and the first row.

### (Example of Operation of Information Processing Apparatus 100)

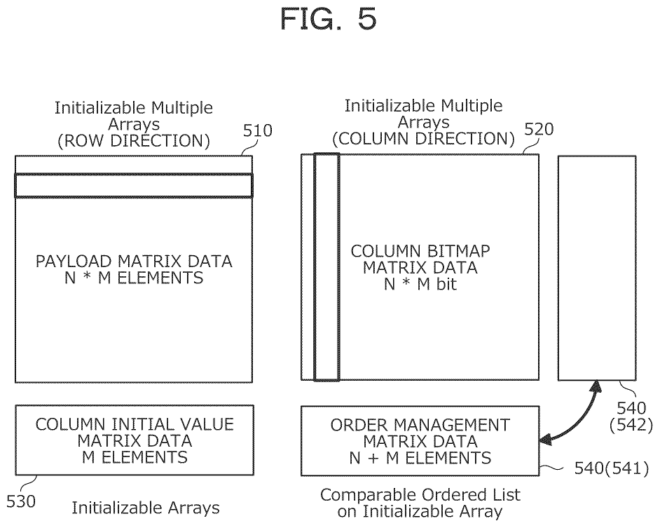

Next, an example of the operation of the information processing apparatus 100 will be described with reference to FIGS. 5 to 19. For example, first, an example of the storage contents of the information processing apparatus 100 will be described with reference to FIG. 5.

FIG. 5 is an explanatory diagram illustrating an example of the storage contents of the information processing apparatus 100. In FIG. 5, the information processing apparatus 100 stores payload matrix data 510 representing a plurality of arrays. The rows of the payload matrix data 510 represent different arrays. The payload matrix data 510 includes an element group in a matrix shape of M rows and N columns. For example, the payload matrix data 510 holds data of components of an array as elements. For example, each row of the payload matrix data 510 is divided into blocks including a predetermined number of elements. For example, a block is associated with data of a predetermined number of components, and may hold the data of the predetermined number of components as the predetermined number of elements.

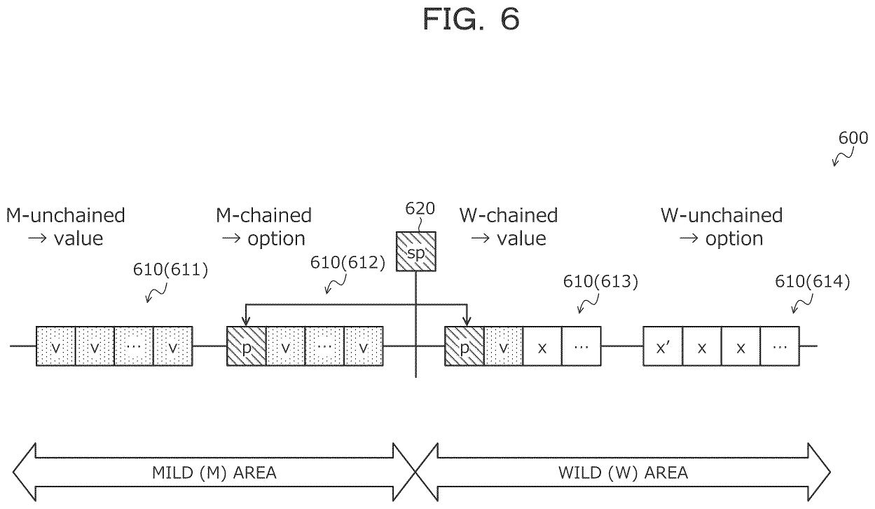

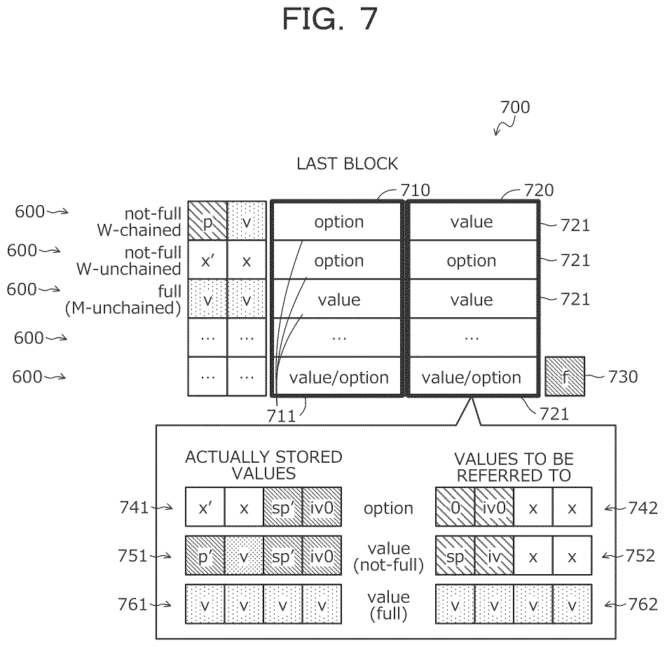

For example, the payload matrix data 510 is treated as a data structure called initializable multiple arrays, which will be described later with reference to FIGS. 6 and 7, in the row direction. Accordingly, each row of the payload matrix data 510 may be collectively initialized in the row direction. The processing load and processing time taken when each row of the payload matrix data 510 is collectively initialized in the row direction are considered to be as large as O (1). For example, the payload matrix data 510 corresponds to the first matrix data described above.

The information processing apparatus 100 stores column bitmap matrix data 520. The column bitmap matrix data 520 includes an element group in a matrix shape of M rows and N columns. An element is a 1-bit value. For example, the column bitmap matrix data 520 holds, as an element, a flag indicating whether any element of the payload matrix data 510 is in the initialized state in which data is collectively initialized in the column direction. For example, each column of the column bitmap matrix data 520 is divided into blocks including a predetermined number of elements. For example, a block is associated with a predetermined number of flags, and may hold the predetermined number of flags as the predetermined number of elements.

For example, the column bitmap matrix data 520 is treated as the data structure called initializable multiple arrays, which will be described later with reference to FIGS. 6 and 7, in the column direction. Accordingly, each column of the column bitmap matrix data 520 may be collectively initialized in the column direction. The processing load and processing time taken when each column of the column bitmap matrix data 520 is collectively initialized in the column direction are considered to be as large as O (1). For example, the column bitmap matrix data 520 corresponds to the second matrix data described above.

The information processing apparatus 100 stores column initial value matrix data 530. For example, the column initial value matrix data 530 includes an element group of one row and N columns. For example, the column initial value matrix data 530 holds, in association with each column of the payload matrix data 510, as an element, a column initial value which is regarded as the initial value of each data in the column in a case where the data in the column is collectively initialized.

For example, the column initial value matrix data 530 is treated as a data structure called initializable arrays. Accordingly, the column initial value matrix data 530 may be collectively initialized. The processing load and processing time taken when the column initial value matrix data 530 is collectively initialized are considered to be as large as O (1). For example, the column initial value matrix data 530 corresponds to the third matrix data described above.

The information processing apparatus 100 stores order management matrix data 540. For example, the order management matrix data 540 includes at least an element group of one row and N+M columns. For example, the first column to the Mth column in an element group 542 correspond to the first row to the Mth row of the payload matrix data 510, respectively. For example, the (M+1)th column to the (M+N)th column in an element group 541 correspond to the first column to the Nth column of the payload matrix data 510, respectively.

The order management matrix data 540 holds, as an element, a value indicating the number of order of initialization of each row and each column of the payload matrix data 510. For example, the order management matrix data 540 holds, in association with each row of the payload matrix data 510, a value indicating the number of order of initialization in which the row is collectively initialized among the rows and columns of the payload matrix data 510. For example, the order management matrix data 540 holds, in association with each column of the payload matrix data 510, a value indicating the number of order of initialization in which the column is collectively initialized among the rows and columns of the payload matrix data 510.

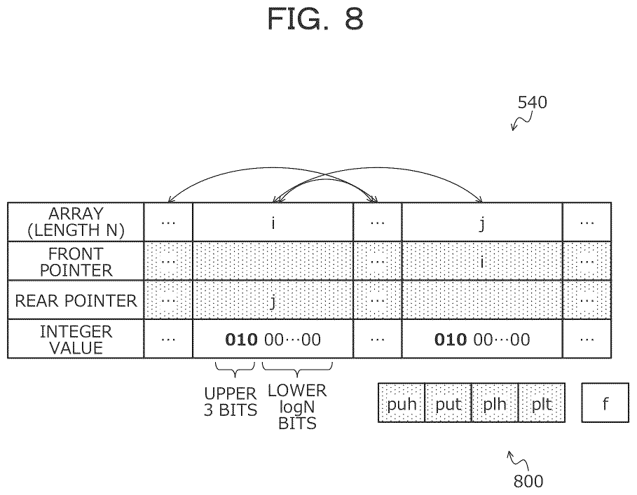

For example, the order management matrix data 540 is treated as a data structure called comparable ordered list on initializable array, which will be described later with reference to FIGS. 8 to 12. For example, the order management matrix data 540 corresponds to the fourth matrix data described above.

Next, an example of the data structure of the payload matrix data 510 stored in the information processing apparatus 100 will be described with reference to FIGS. 6 and 7.

FIGS. 6 and 7 are explanatory diagrams illustrating an example of the data structure of the payload matrix data 510. As illustrated in FIG. 6, the information processing apparatus 100 treats each row of the payload matrix data 510 as a block string 600. For example, the block string 600 is formed by connecting a plurality of blocks 610 each associated with a predetermined number of components of an array. The block string 600 represents an array. For example, the block string 600 has the data structure called OSIA.

For example, the block string 600 is divided into two front and rear portions. For example, the position at which the block string 600 is divided is indicated by a stack pointer 620. For example, the position at which the block string 600 is divided is variable. In the following description, there are cases where the first half portion of the two portions obtained by dividing the block string 600 is referred to as the “mild (M) area”. In the following description, there are cases where the latter half portion of the two portions obtained by dividing the block string 600 is referred to as the “wild (W) area”.

The block 610 includes a predetermined number of areas. For example, an area may store the value of a component as an element of the payload matrix data 510. For example, an area may be capable of storing a pointer to any block 610. For example, the block 610 is in one of a value state and an option state. For example, the block 610 is in the option state when none of the values of the predetermined number of components associated with the block 610 have been set. For example, the values of the predetermined number of components associated with the block 610 in the option state are treated as the set row initial value. For example, the values of the predetermined number of components associated with the block 610 in the option state may be treated as the set column initial value. For example, the block 610 is in the value state when the value of at least any component associated with the block 610 has been set.

When all components of an array have been stored in the block string 600 as elements and there is no block in the option state, there are cases where the state of the block string 600 is referred to as a “full state”. In the following description, when there is a component of an array for which a value has not been set and there is a block in the option state in the block string 600, there are cases where the state of the block string 600 is referred to as a “not-full state”.

For example, a block 611 in the value state in the M area stores the value v of at least any component associated with the block 611 itself. For example, the block 611 in the value state in the M area may store the set row initial value or column initial value for the value of a component whose value has not been set among the predetermined number of components associated with the block 611. In the example of FIG. 6, for example, the block 611 in the value state in the M area stores the value of each component of the predetermined number of components associated with the block 611 in each area of the predetermined number of areas of the block 611.

For example, a block 612 in the option state in the M area is the distribution destination to which the values of (predetermined number−1) components from the first component are distributed among the predetermined number of components associated with a block 613 in the value state in the W area. For example, the block 612 in the option state in the M area stores, in the head area of the predetermined number of areas of the block 612, a pointer to the block 613 in the value state in the W area being the distribution source of distributing the values of (predetermined number−1) components. For example, the block 612 in the option state in the M area stores the value of each component of the above-described (predetermined number−1) components in the remaining areas of the predetermined number of areas of the block 612 other than the head area.

For example, the block 613 in the value state in the W area is the distribution source of distributing, to the block 612 in the option state in the M area, the values of (predetermined number−1) components from the first component among the predetermined number of components associated with the block 613. For example, the block 613 in the value state in the W area stores, in the head area of the predetermined number of areas of the block 613, a pointer to the block 612 in the option state in the M area being the distribution destination to which the values of (predetermined number−1) components are distributed. For example, the block 613 in the value state in the W area stores the value of the last component of the predetermined number of components associated with the block 613, in the second area from the head area of the predetermined number of areas of the block 613.

For example, the values of components are not stored in a block 614 in the option state in the W area. For example, the block 614 in the option state in the W area stores an arbitrary value that is not a pointer to any of the blocks 610 in the head area of the predetermined number of areas of the block 614. For example, the block 614 in the option state of the W area stores the arbitrary value in the remaining areas of the predetermined number of areas of the block 614 other than the head area.

Every time the value of a component of an array is set, the block string 600 is updated. For example, in response to the value of a component of an array having been set, the position indicated by the stack pointer 620 for the block string 600 may be updated, and the M area and the W area may be updated. For example, in response to the value of a component of an array having been set, the state of the block 610 may be updated to the value state or the option state.

Until immediately before the values of all components of an array are set, the last block 610 of the block string 600 is in one of the value state in the W area and the option state in the W area. For this reason, until immediately before the values of all components of an array are set, (predetermined number−2) areas of the predetermined number of areas of the last block 610 of the block string 600 excluding the first two areas are areas in which the values of components are not stored. Until immediately before the values of all components of an array are set, a pointer to another block 610 and the value of one component may be stored in the first two areas of the predetermined number of areas of the last block 610 of the block string 600.

For example, until immediately before the values of all components of an array are set, the stack pointer 620 for the block string 600 is stored by using (predetermined number−2) areas of the predetermined number of areas of the last block 610 of the block string 600 excluding the first two areas. For example, until immediately before the values of all components of an array are set, the row initial value for the values of the predetermined number of components associated with the block 610 in the option state is stored by using the above-described (predetermined number−2) areas of the predetermined number of areas of the last block 610.

The information processing apparatus 100 divides (predetermined number−2) areas in the last block 610 of each block string 600 in which the values of components are not stored, into a first area 711 and a second area 721. For example, the first area 711 does not include an area that stores the stack pointer 620 for the block string 600 in the predetermined number of areas of the last block 610. For example, the first area 711 does not include an area that stores the row initial value for the values of the predetermined number of components associated with the block 610 in the option state in the predetermined number of areas of the last block 610. For example, the first area 711 includes at least two areas. For example, the second area 721 includes at least two areas.

The information processing apparatus 100 manages the first area 711 in the last block 610 of each block string 600 as a first area string 710 in which the first areas 711 are connected. For example, each area included in the first area 711 may store the value of a component. For example, any area included in the first area 711 may be capable of storing a pointer to another first area 711 different from the first area 711. For example, the information processing apparatus 100 manages the first area string 710 as the data structure called OSIA.

As in the case of the block string 600, for example, the first area string 710 is divided into two front and rear portions. For example, the position at which the first area string 710 is divided is indicated by a stack pointer. For example, the position at which the first area string 710 is divided is variable. In the following description, as in the case of the block string 600, there are cases where the first half portion of the two portions obtained by dividing the first area string 710 is referred to as the “mild (M) area”. In the following description, as in the case of the block string 600, there are cases where the latter half portion of the two portions obtained by dividing the first area string 710 is referred to as the “wild (W) area”.

For example, the first area 711 is in one of the value state and the option state. For example, the first area 711 is in the option state when none of the values of the components associated with the first area 711 are stored. For example, the first area 711 is in the option state when the block string 600 including the first area 711 is in the not-full state. For example, the values of the predetermined number of components associated with the first area 711 in the option state may be treated as the initial value set for the first area 711.

For example, the first area 711 is in the value state when the value of at least any component associated with the first area 711 is stored. For example, the first area 711 is in the value state when the block string 600 including the first area 711 is in the full state. As described above, the state of the first area 711 may be used as information indicating whether the block string 600 including the first area 711 is in the full state or the not-full state.

For example, the first area 711 in the value state in the M area stores the value of at least any component associated with the first area 711 itself. For example, the first area 711 in the value state in the M area may store the initial value set for the first area 711 for the value of a component whose value has not been set among the components associated with the first area 711.

For example, the first area 711 in the option state in the M area is the distribution destination to which the values of the components associated with the first area 711 in the value state in the W area are distributed. For example, the first area 711 in the option state in the M area stores, in the head area of the first area 711, a pointer to the first area 711 in the value state in the W area being the distribution source of distributing the values of components. For example, the first area 711 in the option state in the M area stores the above-described values of components in the remaining areas of the first area 711 other than the head area.

For example, the first area 711 in the value state in the W area is the distribution source of distributing the values of the components associated with the first area 711 to the first area 711 in the option state in the M area. For example, the first area 711 in the value state in the W area stores, in the head area of the first area 711, a pointer to the first area 711 in the option state in the M area being the distribution destination to which the values of components are distributed. For example, the first area 711 in the value state in the W area stores the value of the last component of the components associated with the first area 711 in the second area from the head area of the first area 711.

For example, the values of components are not stored in the first area 711 in the option state in the W area. For example, the first area 711 in the option state in the W area stores an arbitrary value that is not a pointer to any of the first areas 711 in the head area of the first area 711. For example, the first area 711 in the option state in the W area stores the arbitrary value in the remaining areas of the first area 711 other than the head area.

Every time the value of a component associated with the last block 610 of any block string 600 is set, the first area string 710 is updated. For example, in response to the value of a component having been set, the position indicated by the stack pointer for the first area string 710 may be updated, and the M area and the W area may be updated. For example, in response to the value of a component having been set, the state of the first area 711 may be updated to the value state or the option state.

Until immediately before the values of all components associated with the first area string 710 are set, the first area 711 at the end of the first area string 710 is in one of the value state in the W area and the option state in the W area. For this reason, until immediately before the values of all components associated with the first area string 710 are set, the remaining areas of the first area 711 at the end of the first area string 710 excluding the first two areas are areas in which the values of components are not set.

For example, until immediately before the values of all components associated with the first area string 710 are set, the stack pointer for the first area string 710 is stored in the above-described remaining areas of the first area 711 at the end of the first area string 710. For example, until immediately before the values of all components associated with the first area string 710 are set, the initial value for the values of the components associated with the first area 711 in the option state may be stored in the above-described remaining areas in the first area string 710.

When the values of all components of an array indicated by each block string 600 have been set, an area in which the value of a component is not set does not exist in the plurality of block strings 600. For example, when the values of all components of an array indicated by each block string 600 have been set, the first area 711 in the option state does not exist in the first area string 710. For this reason, the first area 711 at the end of the first area string 710 does not include an area in which the value of a component is not stored. Accordingly, when the values of all components of an array indicated by each block string 600 have been set, the stack pointer for the first area string 710 may not be stored in the first area 711 at the end of the first area string 710. In this case, the W area does not exist.

Accordingly, the information processing apparatus 100 stores flag information 730 indicating whether the first area string 710 does not include the first area 711 in the option state and the first area string 710 is in the full state. For example, the value 1 of the flag information 730 indicates that there is no first area 711 in the option state and the first area string 710 is in the full state. For example, the value 0 of the flag information 730 indicates that there is the first area 711 in the option state and the first area string 710 is in the not-full state.

Accordingly, the information processing apparatus 100 may manage whether the block string 600 including the first area 711 is in the full state according to the state of the first area 711. The information processing apparatus 100 may manage whether the first area string 710 is in the full state based on the flag information 730. Accordingly, the information processing apparatus 100 may achieve reduction of the amount of data used when the payload matrix data 510 is stored.

On the other hand, the information processing apparatus 100 manages the second area 721 in the last block 610 of each block string 600 as a second area string 720 in which the second areas 721 are connected. For example, the information processing apparatus 100 manages the second area string 720 as the data structure called OSIA.

For example, the second area 721 includes the area that stores the stack pointer 620 in the predetermined number of areas of the last block 610. For example, the second area 721 includes the area that stores the row initial value for the values of the predetermined number of components associated with the block 610 in the option state in the predetermined number of areas of the last block 610.

In the following description, for example, the second area 721 includes four areas. For example, an area may store the stack pointer 620 for the block string 600. For example, an area may store the row initial value for the values of the predetermined number of components associated with the block 610 in the option state. For example, an area may store the value of a component.

As in the case of the block string 600, for example, the second area string 720 is divided into two front and rear portions. For example, the position at which the second area string 720 is divided is indicated by a stack pointer. For example, the position at which the second area string 720 is divided is variable. In the following description, as in the case of the block string 600, there are cases where the first half portion of the two portions obtained by dividing the second area string 720 is referred to as the “mild (M) area”. In the following description, as in the case of the block string 600, there are cases where the latter half portion of the two portions obtained by dividing the second area string 720 is referred to as the “wild (W) area”.

For example, the second area 721 is in one of the value state and the option state. For example, the second area 721 is in the option state when the values of the components associated with the second area 721 are not stored and a pair of the stack pointer 620 and a row initial value is not stored. For example, the second area 721 is in the option state when the block string 600 including the second area 721 is in the initial state. When the second area 721 is in the option state, the pair of the stack pointer for the block string 600 including the second area 721 and a row initial value is treated as an initial pair set for the second area string 720.

For example, the second area 721 is in the value state when the values of the components associated with the second area 721 are stored. For example, the second area 721 is in the value state when the block string 600 including the second area 721 is in the full state. When the block string 600 is in the full state, the first area 711 of the block string is in the value state. Accordingly, in a case where the first area 711 of the block string 600 including the second area 721 is in the value state, when the second area 721 is also in the value state, the second area 721 is treated as storing the values of the components associated with the second area 721.

On the other hand, for example, the second area 721 is also in the value state when the pair of the stack pointer 620 and a row initial value is stored. For example, the second area 721 is in the value state when the block string 600 including the second area 721 is in the not-full state. When the block string 600 is in the not-full state, the first area 711 of the block string is in the option state. Accordingly, in a case where the first area 711 of the block string 600 including the second area 721 is in the option state, when the second area 721 is in the value state, the second area 721 is treated as storing the pair of the stack pointer 620 and a row initial value.

As described above, a combination of the state of the first area 711 and the state of the second area 721 indicates whether the second area 721 is empty, stores the values of components, or stores the pair of the stack pointer 620 and a row initial value.

For example, there is a case where the second area 721 in the value state in the M area stores the value v of at least any component associated with the second area 721 itself. In this case, for example, the second area 721 in the value state in the M area may store the initial value set for the second area string 720 for the value of a component whose value has not been set among the components associated with the second area 721. For example, there is also a case where the second area 721 in the value state in the M area stores the pair of the stack pointer 620 and a row initial value.

For example, there is a case where the second area 721 in the option state in the M area is the distribution destination to which the values of the components associated with the second area 721 in the value state in the W area are distributed. In this case, for example, the second area 721 in the option state in the M area stores, in the head area of the second area 721, a pointer to the second area 721 in the value state in the W area being the distribution source. In this case, for example, the second area 721 in the option state in the M area stores the above-described values of components in the remaining areas of the second area 721 other than the head area.

For example, there is also a case where the second area 721 in the option state in the M area is the distribution destination to which the pair of the stack pointer 620 for the block string 600 including the second area 721 in the value state in the W area and a row initial value is distributed. In this case, for example, the second area 721 in the option state in the M area stores, in the head area of the second area 721, a pointer to the second area 721 in the value state in the W area being the distribution source. In this case, for example, the second area 721 in the option state in the M area stores the above-described pair of the stack pointer 620 and a row initial value in the remaining areas of the second area 721 other than the head area.

For example, there is a case where the second area 721 in the value state in the W area is the distribution source of distributing the values of the components associated with the second area 721 to the second area 721 in the option state in the M area. In this case, for example, the second area 721 in the value state in the W area stores, in the head area of the second area 721, a pointer to the second area 721 in the option state in the M area being the distribution destination to which the values of components are distributed. In this case, for example, the second area 721 in the value state in the W area stores the value of the last component of the components associated with the second area 721 in the second area from the head area of the second area 721.

For example, there is a case where the second area 721 in the value state in the W area is the distribution source of distributing the pair of the stack pointer 620 for the block string 600 including the second area 721 and a row initial value to the second area 721 in the option state in the M area. In this case, for example, the second area 721 in the value state in the W area stores, in the head area of the second area 721, a pointer to the second area 721 in the option state in the M area being the distribution destination. In this case, for example, the second area 721 in the value state in the W area may empty the remaining areas of the second area 721 other than the head area.

For example, the values of components are not stored in the second area 721 in the option state in the W area. For example, the second area 721 in the option state in the W area does not store the pair of the stack pointer 620 for the block string 600 including the second area 721 and a row initial value. For example, the second area 721 in the option state in the W area stores an arbitrary value that is not a pointer to any of the second areas 721 in the head area of the second area 721. For example, the second area 721 in the option state in the W area stores the arbitrary value in the remaining areas of the second area 721 other than the head area.

Every time the value of a component associated with the last block 610 of any block string 600 is set, the second area string 720 is updated. For example, in response to the value of a component having been set, the position indicated by the stack pointer for the second area string 720 may be updated, and the M area and the W area may be updated. For example, in response to the value of a component having been set, the state of the second area 721 may be updated to the value state or the option state.

Every time the pair of the stack pointer 620 for any block string 600 and a row initial value is set or updated, the second area string 720 is updated. For example, in response to the pair of the stack pointer 620 and a row initial value having been set, the position indicated by the stack pointer for the second area string 720 may be updated, and the M area and the W area may be updated. For example, in response to the pair of the stack pointer 620 and a row initial value having been set, the state of the second area 721 may be updated to the value state or the option state.

Until immediately before all of the second areas 721 are in the value state in the M area, the second area 721 at the end of the second area string 720 is in one of the value state in the W area or the option state in the W area. For this reason, until immediately before all of the second areas 721 are in the value state in the M area, the remaining areas of the second area 721 at the end of the second area string 720 excluding the first two areas are empty areas.

For example, until immediately before all of the second areas 721 are in the value state in the M area, the stack pointer for the second area string 720 is stored in the above-described remaining areas of the second area 721 at the end of the second area string 720. For example, until immediately before all of the second areas 721 are in the value state in the M area, an initial pair for the pair of the stack pointer 620 for the block string 600 and a row initial value is stored in the above-described remaining areas of the second area 721 at the end.

Accordingly, when the second area 721 of the block string 600 is in the value state, the information processing apparatus 100 may manage the type of information stored in the second area 721 according to the state of the first area 711 of the block string 600. For example, when the first area 711 is in the option state in the case where the second area 721 is in the value state, the information processing apparatus 100 may determine that the second area 721 stores the pair of the stack pointer 620 and a row initial value. On the other hand, for example, when the first area 711 is in the value state in the case where the second area 721 is in the value state, the information processing apparatus 100 may determine that the second area 721 stores the value of a component.

For example, when the contents of any second area 721 in the option state are actually the contents indicated by reference sign 741, the information processing apparatus 100 recognizes that the any second area 721 presents the contents indicated by reference sign 742. For example, when any second area 721 is in the option state, the information processing apparatus 100 recognizes that the any second area 721 presents the initial pair that has been stored in the second area 721 at the end. The initial pair is a pair of the stack pointer=0 indicating the head of the block string 600 and the row initial value iv0 for the values of the predetermined number of components associated with the block 610 in the option state of the block string 600.

For example, a case may be considered in which, since the first area 711 is in the option state, the block string 600 including the first area 711 is in the not-full state, and any second area 721 of the block string 600 is in the value state. For example, any second area 721 in this case is the second area 721 at the end. In this case, for example, when the contents of any second area 721 are actually the contents indicated by reference sign 751, the information processing apparatus 100 recognizes that the any second area 721 presents the contents indicated by reference sign 752. For example, the information processing apparatus 100 recognizes that any second area 721 presents a pair of the stack pointer sp and the row initial value iv, which has been stored in another second area 721 indicated by the pointer p stored in the head area of the any second area 721.

For example, a case may be considered in which, since the first area 711 is in the value state, the block string 600 including the first area 711 is in the full state, and any second area 721 of the block string 600 is in the value state. In this case, for example, when the contents of any second area 721 are actually the contents indicated by reference sign 761, the information processing apparatus 100 recognizes that the any second area 721 presents the contents indicated by reference sign 762. The contents indicated by reference sign 762 are the same as the contents indicated by reference sign 761. For example, the information processing apparatus 100 recognizes that the contents of any second area 721 are the contents indicated by reference sign 761 themselves.

The information processing apparatus 100 may collectively update the pair of the stack pointer 620 for each block string 600 and a row initial value to the initial pair by initializing the second area string 720. For example, the information processing apparatus 100 may initialize the second area string 720 by initializing the stack pointer for the second area string 720 and the initial pair in the second area 721 at the end of the second area string 720. For this reason, the information processing apparatus 100 may reduce the processing load and processing time taken when the entire payload matrix data 510 is initialized to O (1).

Next, an example of the data structure of the column bitmap matrix data 520 stored in the information processing apparatus 100 will be described. For example, the data structure of the column bitmap matrix data 520 is a data structure in which the row direction and the column direction in the data structure called initializable multiple arrays illustrated in FIGS. 6 and 7 are exchanged.

Accordingly, the information processing apparatus 100 may make it easier to collectively initialize a plurality of pieces of data in each column of the column bitmap matrix data 520 in the column direction. For example, the information processing apparatus 100 may reduce the processing load and processing time taken when a plurality of pieces of data in a column of the column bitmap matrix data 520 is collectively initialized in the column direction to O (1). The information processing apparatus 100 may make it easier to collectively initialize the entire column bitmap matrix data 520. For example, the information processing apparatus 100 may reduce the processing load and processing time taken when the entire column bitmap matrix data 520 is initialized to O (1).

Next, an example of the data structure of the column initial value matrix data 530 stored in the information processing apparatus 100 will be described. For example, the column initial value matrix data 530 has the data structure called initializable arrays. For example, the column initial value matrix data 530 has the data structure called OSIA illustrated in FIG. 6, which is a type of the structure called initializable array.

Accordingly, the information processing apparatus 100 may make it easier to collectively initialize a plurality of pieces of data of the column initial value matrix data 530. For example, the information processing apparatus 100 may reduce the processing load and processing time taken when the plurality of pieces of data of the column initial value matrix data 530 is collectively initialized to O (1).

Next, an example of the data structure of the order management matrix data 540 stored in the information processing apparatus 100 will be described with reference to FIGS. 8 to 12.

FIGS. 8 to 12 are explanatory diagrams illustrating an example of a data structure of the order management matrix data 540. In FIG. 8, the information processing apparatus 100 stores the order management matrix data 540. For example, the order management matrix data 540 is realized by the storage area such as the memory 302 or the recording medium 305 of the information processing apparatus 100 illustrated in FIG. 3.

The order management matrix data 540 includes the fields of array, front pointer, rear pointer, and integer value. In the order management matrix data 540, each of M+N pieces of order management information is stored as a record by setting information in each field for each row or column of the payload matrix data 510.

In the array field, an id that enables identification of a row or column of the payload matrix data 510 is set. For example, the values 1 to M of an id indicate the first row to the Mth row of the payload matrix. For example, the values M+1 to M+N of an id indicate the first column to the Nth column of the payload matrix.

In the front pointer field, an index of another id that comes immediately before the above id is set. In the rear pointer field, an index of another id that comes immediately after the above id is set.

In the integer value field, an integer value being a counter associated with the above id is set. An integer value is information for managing the number of order of initialization of a row or column of the payload matrix indicated by the above id. An integer value is a value of the number of digits of (log N+3).

For example, an upper range, an intermediate range 1, an intermediate range 2, and a lower range are set for an integer value. For example, in the initial state, a first range of “1111 . . . 1” to “1100 . . . 0” is set as the upper range. For example, in the initial state, a second range of “1011 . . . 1” to “1000 . . . 0” is set as the intermediate range 1. For example, there is a case where the ranges set as the upper range and the intermediate range 1 are replaced with each other, and the second range of “1011 . . . 1” to “1000 . . . 0” is set as the upper range.

For example, in the initial state, a third range of “0111 . . . 1” to “0100 . . . 0” is set as the intermediate range 2. For example, in the initial state, a fourth range of “0011 . . . 1” to “0000 . . . 0” is set as the lower range. For example, there is a case where the ranges set as the intermediate range 2 and the lower range are replaced with each other, and the fourth range of “0011 . . . 1” to “0000 . . . 0” is set as the lower range.

The number of order of initialization of an id corresponding to an integer value belonging to the upper range is treated as the number of order of initialization that comes before the number of order of initialization of an id corresponding to an integer value belonging to the intermediate range 1. The number of order of initialization of an id corresponding to an integer value belonging to the intermediate range 1 is treated as the number of order of initialization that comes before the number of order of initialization of an id corresponding to an integer value belonging to the intermediate range 2. The number of order of initialization of an id corresponding to an integer value belonging to the intermediate range 2 is treated as the number of order of initialization that comes before the number of order of initialization of an id corresponding to an integer value belonging to the lower range.

The number of order of initialization of an id corresponding to a first integer value belonging to the upper range is treated as the number of order of initialization that comes before the number of order of initialization of an id corresponding to a second integer value smaller than the first integer value belonging to the same upper range. The number of order of initialization of an id corresponding to a first integer value belonging to the intermediate range 1 is treated as the number of order of initialization that comes before the number of order of initialization of an id corresponding to a second integer value smaller than the first integer value belonging to the same intermediate range 1.

The number of order of initialization of an id corresponding to a first integer value belonging to the intermediate range 2 is treated as the number of order of initialization that comes before the number of order of initialization of an id corresponding to a second integer value smaller than the first integer value belonging to the same intermediate range 2. The number of order of initialization of an id corresponding to a first integer value belonging to the lower range is treated as the number of order of initialization that comes before the number of order of initialization of an id corresponding to a second integer value smaller than the first integer value belonging to the same lower range.

The information processing apparatus 100 stores range pointers 800. The range pointers are puh, put, plh, and plt. puh is a pointer that enables identification of the first id among the ids corresponding to the integer values belonging to the upper range. puh indicates an integer value corresponding to the first id among the ids corresponding to the integer values belonging to the upper range. put is a pointer that enables identification of the last id among the ids corresponding to the integer values belonging to the upper range. put indicates an integer value corresponding to the last id among the ids corresponding to the integer values belonging to the upper range.

plh is a pointer that enables identification of the first id among the ids corresponding to the integer values belonging to the lower range. plh indicates an integer value corresponding to the first id among the ids corresponding to the integer values belonging to the lower range. plt is a pointer that enables identification of the last id among the ids corresponding to the integer values belonging to the lower range. plt indicates an integer value corresponding to the last id among the ids corresponding to the integer values belonging to the lower range.

The information processing apparatus 100 stores flag information f. Flag information f is information for managing the ranges to be set as the upper range and the intermediate range 1, and the ranges to be set as the intermediate range 2 and the lower range.

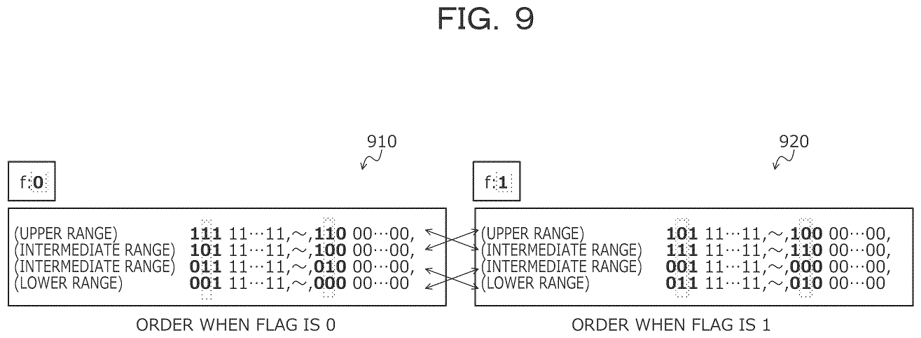

For example, the data structure of the order management matrix data 540 illustrated in FIG. 8 is the data structure called comparable ordered list on initializable array. Next, an example of the relationship between flag information and various ranges will be described with reference to FIG. 9. For example, the various ranges are the upper range, the intermediate range 1, the intermediate range 2, and the lower range.

For example, as indicated by reference sign 910 in FIG. 9, the value 0 of the flag information f indicates that the first range is set as the upper range, the second range is set as the intermediate range 1, the third range is set as the intermediate range 2, and the fourth range is set as the lower range.

For example, as indicated by reference sign 920 in FIG. 9, the value 1 of the flag information f indicates that the second range is set as the upper range, the first range is set as the intermediate range 1, the fourth range is set as the intermediate range 2, and the third range is set as the lower range.

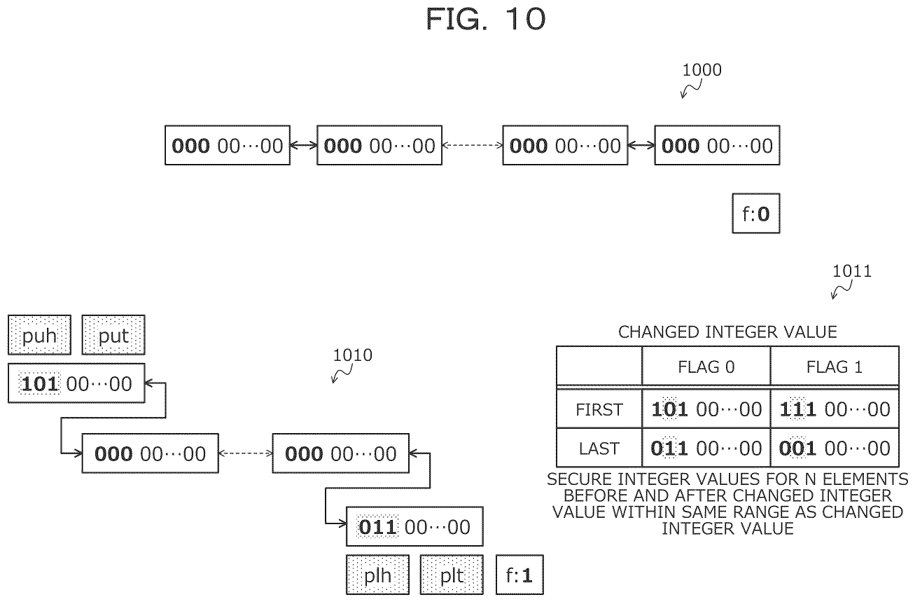

As described above, the information processing apparatus 100 may change the order for the first range, the second range, the third range, and the fourth range by using the flag information. Next, an example in which the information processing apparatus 100 manages the order of initialization of ids will be described with reference to FIGS. 10 to 12.

As indicated by reference sign 1000 in FIG. 10, the information processing apparatus 100 initializes an integer value being a counter corresponding to all ids to “000 00 . . . 00”. Reference sign 1000 in FIG. 10 indicates a coupling relationship between ids and the integer value corresponding to each id at the time of initialization.

As indicated by reference sign 1000, the information processing apparatus 100 sets flag information f=0. Accordingly, the information processing apparatus 100 may initialize the order management matrix data 540, and may start management of the order of initialization of ids.

As indicated by reference sign 1010, the information processing apparatus 100 updates the integer value corresponding to the first id among all ids. Reference sign 1010 in FIG. 10 indicates a coupling relationship between ids and the integer value corresponding to each id after the update.

For example, when flag information f=0, the information processing apparatus 100 sets “101 00 . . . 00” as the integer value corresponding to the first id in accordance with table 1011. For example, when flag information f=1, the information processing apparatus 100 sets “111 00 . . . 00” as the integer value corresponding to the first id in accordance with table 1011. In the example of FIG. 10, for example, the information processing apparatus 100 sets “101 00 . . . 00” as the integer value corresponding to the first id.

As indicated by reference sign 1010, the information processing apparatus 100 updates the integer value corresponding to the last id among all ids. For example, when flag information f=0, the information processing apparatus 100 sets “001 00 . . . 00” as the integer value corresponding to the last id in accordance with table 1011. For example, when flag information f=1, the information processing apparatus 100 sets “011 00 . . . 00” as the integer value corresponding to the last id in accordance with table 1011. In the example of FIG. 10, for example, the information processing apparatus 100 sets “101 00 . . . 00” as the integer value corresponding to the last id.

The information processing apparatus 100 inverts the flag information f. In the example of FIG. 10, for example, the information processing apparatus 100 sets flag information f=1. The information processing apparatus 100 sets the integer value “101 00 . . . 00” corresponding to the first id for puh and put. The information processing apparatus 100 sets the integer value “101 00 . . . 00” corresponding to the last id for plh and plt.

Accordingly, the information processing apparatus 100 may cause the first id to belong to the upper range. Within the upper range, the information processing apparatus 100 may secure unused integer values for N ids before and after the integer value corresponding to the first id. For this reason, the information processing apparatus 100 may enable management of up to N other ids, in addition to the first id, as ids of which the number of order of initialization is before the number of order of initialization of the first id. Similarly, the information processing apparatus 100 may enable management of up to N other ids, in addition to the first id, as ids of which the number of order of initialization is after the number of order of initialization of the first id. Accordingly, the information processing apparatus 100 may secure unused integer values, and may appropriately manage the order of initialization of all ids.

Similarly, the information processing apparatus 100 may cause the last id to belong to the lower range. Within the lower range, the information processing apparatus 100 may secure unused integer values for N ids before and after the integer value corresponding to the last id. For this reason, the information processing apparatus 100 may enable management of up to N other ids, in addition to the last id, as ids of which the number of order of initialization is before the number of order of initialization of the last id. Similarly, the information processing apparatus 100 may enable management of up to N other ids, in addition to the last id, as ids of which the number of order of initialization is after the number of order of initialization of the last id. Accordingly, the information processing apparatus 100 may secure unused integer values, and may appropriately manage the order of initialization of all ids.

Although a case has been described in which the information processing apparatus 100 updates the integer value corresponding to the first id, updates the integer value corresponding to the last id, and then inverts the flag information f, the embodiment is not limited to this case. For example, there may be a case where the information processing apparatus 100 updates the integer value corresponding to the first id and updates the integer value corresponding to the last id after inverting the flag information f.

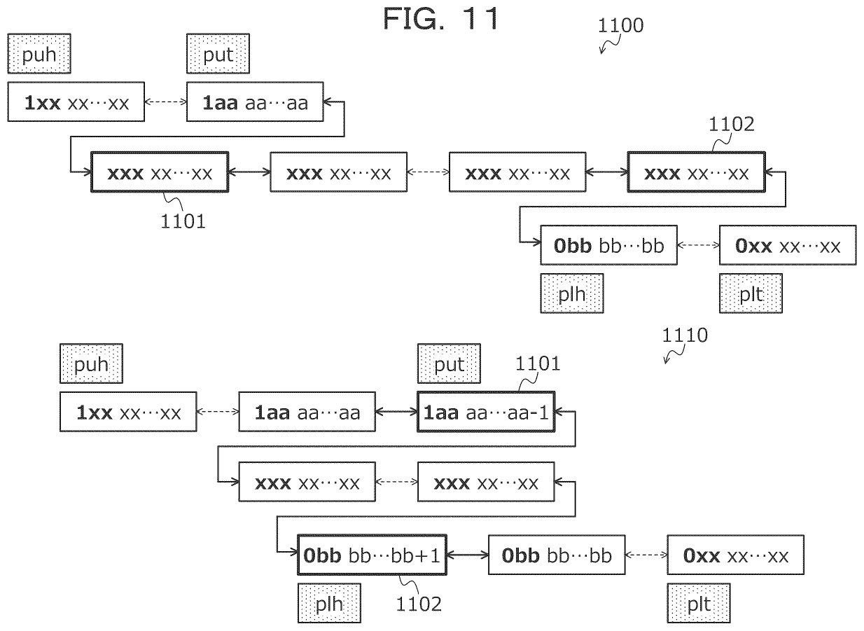

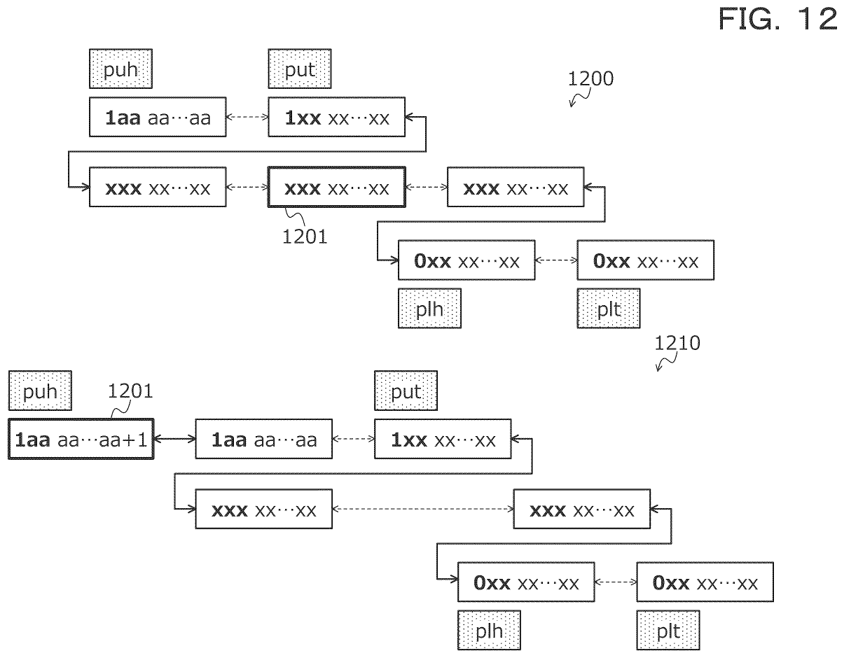

Next, description will be given with reference to FIG. 11 for various types of processing executed by the information processing apparatus 100 when a change query is received that requests a change of the number of order of initialization of any id to the top of the order. A change query is issued when a plurality of pieces of data in a row or column of the payload matrix data 510 is collectively initialized, and the query requests that the order of initialization of the id of the row or the column be changed to the top of the order. For example, the various types of processing include the processing of “averaging movement” described later with reference to FIG. 11. For example, the various types of processing include the processing of “order change” described later with reference to FIG. 12.

In FIG. 11, when a change query is received that requests a change of the number of order of initialization of any id to the top or the end of the order, the information processing apparatus 100 performs averaging movement. Averaging movement is movement of any id belonging to the intermediate range 1 or the intermediate range 2 such that the id belongs to the upper range, and movement of any id belonging to the intermediate range 1 or the intermediate range 2 such that the id belongs to the lower range.

Reference sign 1100 in FIG. 11 indicates a coupling relationship between ids and the integer value corresponding to each id at a certain timing. As indicated by reference sign 1100, the information processing apparatus 100 specifies the first id 1101 of the ids belonging to the intermediate range 1 and the ids belonging to the intermediate range 2, and specifies an integer value corresponding to the first id 1101. As indicated by reference sign 1100, the information processing apparatus 100 specifies the last id 1102 of the ids belonging to the intermediate range 1 and the ids belonging to the intermediate range 2, and specifies an integer value corresponding to the last id 1102.

The information processing apparatus 100 moves the specified first id 1101 of the ids belonging to the intermediate range 1 and the ids belonging to the intermediate range 2 such that the id belongs to the upper range. For example, as indicated by reference sign 1110, the information processing apparatus 100 sets an integer value corresponding to the specified first id 1101 of the ids belonging to the intermediate range 1 and the ids belonging to the intermediate range 2 for puh−1, and sets the set integer value for put. Reference sign 1110 in FIG. 11 indicates a coupling relationship between ids and the integer value corresponding to each id after the processing of averaging movement has been performed.

The information processing apparatus 100 moves the specified last id 1102 of the ids belonging to the intermediate range 1 and the ids belonging to the intermediate range 2 such that the id belongs to the lower range. For example, as indicated by reference sign 1110, the information processing apparatus 100 sets an integer value corresponding to the specified last id 1102 of the ids belonging to the intermediate range 1 and the ids belonging to the intermediate range 2 for plt+1, and sets the set integer value for plh.

Accordingly, the information processing apparatus 100 may ensure that the number of ids belonging to the intermediate range 1 and ids belonging to the intermediate range 2 is reduced by at least one for each change query. The information processing apparatus 100 may ensure that there is at least one or more ids in the upper range and that there is at least one or more ids in the lower range before and after a change query. Accordingly, the information processing apparatus 100 may reduce processing errors. Next, description will be given with reference to FIG. 12.

As indicated by reference sign 1200 in FIG. 12, the information processing apparatus 100 has received a change query that requests a change of the number of order of initialization of id 1201 to the top of the order, and has performed the processing of averaging movement. Reference sign 1200 in FIG. 12 indicates a coupling relationship between ids and the integer value corresponding to each id at a certain timing.

As indicated by reference sign 1210 in FIG. 12, the information processing apparatus 100 performs the processing of order change in accordance with the change query by setting the integer value of id 1201 for which the change query has been received for puh+1 and setting the set integer value for puh. Reference sign 1210 in FIG. 12 indicates a coupling relationship between ids and the integer value corresponding to each id after the processing of order change has been performed.

Accordingly, the information processing apparatus 100 may update the integer value corresponding to id 1201, and change the number of order of initialization of id 1201 to the top of the order. As described above, the information processing apparatus 100 enables the number of order of initialization of an id to be represented by an integer value corresponding to the id.

In a case where there is no id belonging to the intermediate range 1 or id belonging to the intermediate range 2 left due to the processing of averaging movement or the processing of order change, the information processing apparatus 100 inverts the flag information f as in the case of FIG. 10. For example, as in the case of FIG. 10, the information processing apparatus 100 inverts the flag information f after the integer value corresponding to the first id is updated and the integer value corresponding to the last id is updated.

Accordingly, the information processing apparatus 100 may repeatedly use the range of values that may be set as integer values. The information processing apparatus 100 may once again enable the processing of averaging movement and the processing of order change to be performed. For this reason, the information processing apparatus 100 may reduce the cases of exhaustion of the values that may be set as integer values, and may continue to appropriately manage the order of initialization of ids.

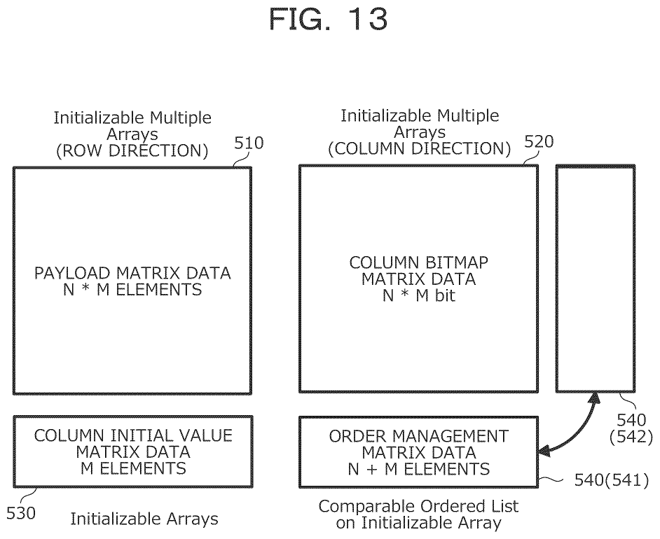

Next, with reference to FIGS. 13 to 17, description will be given for the way in which the information processing apparatus 100 refers to or updates the payload matrix data 510, the column bitmap matrix data 520, the column initial value matrix data 530, and the order management matrix data 540 in response to various queries.

For example, a query may be an entire initialization request that requests collective initialization of the entire payload matrix data 510. Description will be given later with reference to FIG. 13 for the way in which the information processing apparatus 100 refers to or updates the payload matrix data 510, the column bitmap matrix data 520, the column initial value matrix data 530, and the order management matrix data 540 in response to an entire initialization request.

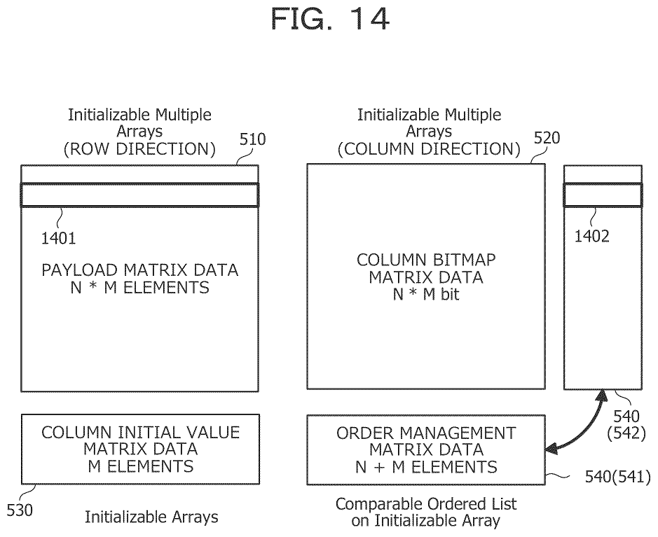

For example, a query may be a row initialization request that requests collective initialization of a plurality of pieces of data in any row of the payload matrix data 510 in the row direction. Description will be given later with reference to FIG. 14 for the way in which the information processing apparatus 100 refers to or updates the payload matrix data 510, the column bitmap matrix data 520, the column initial value matrix data 530, and the order management matrix data 540 in response to a row initialization request.

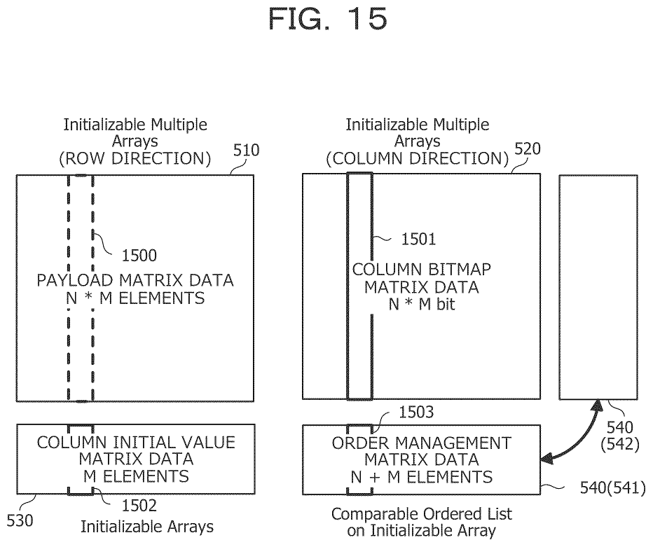

For example, a query may be a column initialization request that requests collective initialization of a plurality of pieces of data in any column of the payload matrix data 510 in the column direction. Description will be given later with reference to FIG. 15 for the way in which the information processing apparatus 100 refers to or updates the payload matrix data 510, the column bitmap matrix data 520, the column initial value matrix data 530, and the order management matrix data 540 in response to a column initialization request.

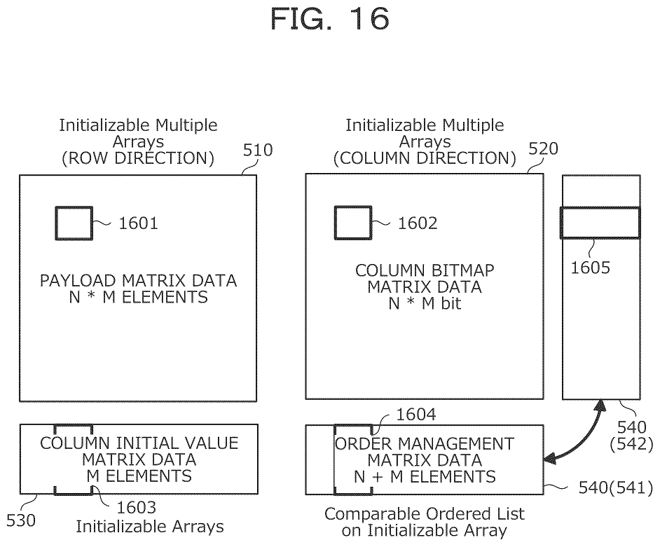

For example, a query may be a read request that requests reading of data of a component of an array from the payload matrix data 510. Description will be given later with reference to FIG. 16 for the way in which the information processing apparatus 100 refers to or updates the payload matrix data 510, the column bitmap matrix data 520, the column initial value matrix data 530, and the order management matrix data 540 in response to a read request.

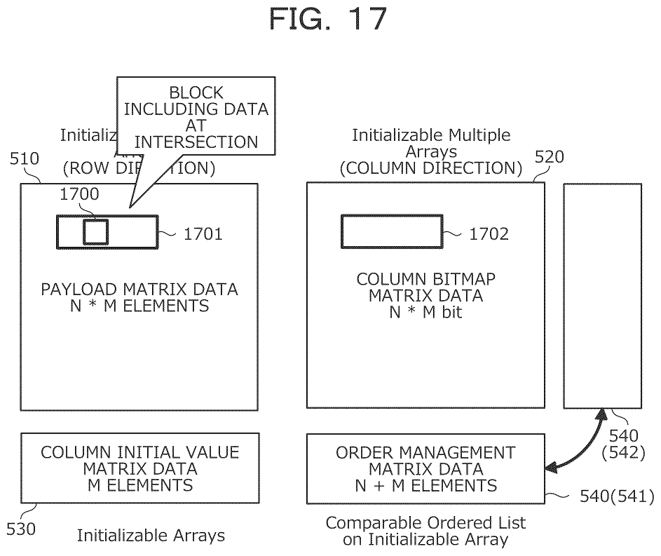

For example, a query may be a write request that requests writing of data of a component of an array to the payload matrix data 510. Description will be given later with reference to FIG. 17 for the way in which the information processing apparatus 100 refers to or updates the payload matrix data 510, the column bitmap matrix data 520, the column initial value matrix data 530, and the order management matrix data 540 in response to a write request.

For example, first, an example in which the information processing apparatus 100 initializes the entire payload matrix data 510 in response to an entire initialization request will be described with reference to FIG. 13.

FIG. 13 is an explanatory diagram illustrating an example of initializing the entire payload matrix data 510. In FIG. 13, the information processing apparatus 100 initializes the payload matrix data 510 in response to an entire initialization request. For example, the information processing apparatus 100 initializes the stack pointer for the first area string 710 in the first area 711 at the end of the first area string 710 of the payload matrix data 510. For example, the information processing apparatus 100 initializes the stack pointer for the second area string 720 illustrated in FIG. 7 in the second area 721 at the end of the second area string 720 of the payload matrix data 510.

For example, the information processing apparatus 100 initializes the payload matrix data 510 by initializing the stack pointer for the first area string 710 and initializing the stack pointer for the second area string 720. Accordingly, the information processing apparatus 100 may reduce the processing load and processing time taken when the payload matrix data 510 is initialized to O (1).

The information processing apparatus 100 initializes the column bitmap matrix data 520 in response to the entire initialization request. For example, the information processing apparatus 100 initializes the column bitmap matrix data 520 by initializing various stack pointers in the column bitmap matrix data 520 in a manner similar to that for the payload matrix data 510. Accordingly, the information processing apparatus 100 sets the value=1 indicating that the data is not in a column initialized state for all flags of the column bitmap matrix data 520. The information processing apparatus 100 may reduce the processing load and processing time taken when the column bitmap matrix data 520 is initialized to O (1).

The information processing apparatus 100 initializes the column initial value matrix data 530 in response to the entire initialization request. For example, the information processing apparatus 100 initializes the column initial value matrix data 530 by initializing the stack pointer for the column initial value matrix data 530 in the block at the end of the column initial value matrix data 530. Accordingly, the information processing apparatus 100 may reduce the processing load and processing time taken when the column initial value matrix data 530 is initialized to O (1).

The information processing apparatus 100 initializes the order management matrix data 540. For example, the information processing apparatus 100 initializes the order management matrix data 540 by setting an integer value corresponding to all ids as an initial value and initializing the flag information f in the order management matrix data 540.

Accordingly, the information processing apparatus 100 may initialize the payload matrix data 510 in response to the entire initialization request. The information processing apparatus 100 may initialize the column bitmap matrix data 520, the column initial value matrix data 530, and the order management matrix data 540 in accordance with the initialized payload matrix data 510. The information processing apparatus 100 may appropriately process the entire initialization request.

Next, an example in which the information processing apparatus 100 initializes a row of the payload matrix data 510 in response to a row initialization request will be described with reference to FIG. 14.

FIG. 14 is an explanatory diagram illustrating an example of initializing a row of the payload matrix data 510. In FIG. 14, the information processing apparatus 100 receives a row initialization request that requests initialization of a row 1401 of the payload matrix data 510 with a designated value.

The information processing apparatus 100 initializes the row 1401 of the payload matrix data 510 in response to the row initialization request. For example, the information processing apparatus 100 refers to the block 610 at the end of the row 1401 of the payload matrix data 510, and initializes the stack pointer for the row 1401 and sets the row initial value for the row 1401 (=designated value) in the second area string 720. For example, the information processing apparatus 100 initializes the row 1401 by initializing the stack pointer for the row 1401 and setting the row initial value for the row 1401 (=designated value).

The information processing apparatus 100 updates the order management matrix data 540 such that the row 1401 is at the top of the order of initialization. For example, the information processing apparatus 100 changes the number of order of initialization of the row 1401 to the top of the order by updating an integer value 1402 corresponding to the row 1401 in the order management matrix data 540.

Accordingly, the information processing apparatus 100 may initialize the row 1401 of the payload matrix data 510 in response to the row initialization request. The information processing apparatus 100 may update the order management matrix data 540 in accordance with the initialized row 1401. The information processing apparatus 100 may appropriately process the row initialization request.

The information processing apparatus 100 may subsequently enable determination that the plurality of pieces of data in the row 1401 is in a row initialized state in which the data is initialized in the row direction. For this reason, the information processing apparatus 100 may subsequently store a guideline for reading the data in the row 1401. The information processing apparatus 100 may subsequently store the row initial value regarded as data of the row 1401.

Next, an example in which the information processing apparatus 100 initializes a column of the payload matrix data 510 in response to a column initialization request will be described with reference to FIG. 15.

FIG. 15 is an explanatory diagram illustrating an example of initializing a column of the payload matrix data 510. In FIG. 15, the information processing apparatus 100 receives a column initialization request that requests initialization of a column 1500 of the payload matrix data 510 with a designated value. The information processing apparatus 100 does not update the payload matrix data 510.

In response to the column initialization request, the information processing apparatus 100 sets 0 indicating the column initialized state for all flags of the column bitmap matrix data 520 corresponding to the column 1500. For example, the information processing apparatus 100 refers to the block at the end of a column 1501 corresponding to the column 1500 in the column bitmap matrix data 520, initializes the stack pointer for the column 1501, and sets the column initial value=0 for the column 1501. For example, the information processing apparatus 100 sets 0 indicating the column initialized state for all flags corresponding to the column 1500 by initializing the stack pointer for the column 1501 and setting the column initial value=0 for the column 1501.

In response to the column initialization request, the information processing apparatus 100 updates a column initial value 1502 in the column initial value matrix data 530 corresponding to the column 1500 to the designated value. Accordingly, the information processing apparatus 100 may subsequently store the column initial value regarded as data of the column 1500.

The information processing apparatus 100 updates the order management matrix data 540 such that the column 1500 is at the top of the order of initialization. For example, the information processing apparatus 100 changes the number of order of initialization of the column 1500 to the top of the order by updating an integer value 1503 corresponding to the column 1500 in the order management matrix data 540.

Accordingly, the information processing apparatus 100 may substantially initialize the column 1500 of the payload matrix data 510 in response to the column initialization request. The information processing apparatus 100 may appropriately process the column initialization request. The information processing apparatus 100 may subsequently enable determination that the plurality of pieces of data in the column 1500 is in the column initialized state in which the data is initialized in the column direction. For this reason, the information processing apparatus 100 may subsequently store a guideline for reading the data in the column 1500.

Next, an example in which the information processing apparatus 100 reads data of a component of an array from the payload matrix data 510 in response to a read request will be described with reference to FIG. 16.

FIG. 16 is an explanatory diagram illustrating an example of reading data of a component of an array. In FIG. 16, the information processing apparatus 100 receives a read request that requests reading of the data at an intersection 1601 of the first row and the first column from the payload matrix data 510.

The information processing apparatus 100 refers to the block 610 at the end of the row corresponding to the intersection 1601 in the payload matrix data 510, and determines whether the data at the intersection 1601 is in the row initialized state based on the second area string 720. The information processing apparatus 100 reads a flag at an intersection 1602 in the column bitmap matrix data 520 corresponding to the intersection 1601, and determines whether the data at the intersection 1601 is in the column initialized state based on the flag.

When the data is not in the row initialized state and is not in the column initialized state, the information processing apparatus 100 reads the data at the intersection 1601 in the payload matrix data 510 itself.

When the data is in the row initialized state and is not in the column initialized state, the information processing apparatus 100 refers to the block 610 at the end of the row corresponding to the intersection 1601 in the payload matrix data 510, and reads the row initial value as the data at the intersection 1601.

When the data is not in the row initialized state and is in the column initialized state, the information processing apparatus 100 reads a column initial value 1603 corresponding to the intersection 1601 in the column initial value matrix data 530 as the data at the intersection 1601.

When the data is in the row initialized state and is in the column initialized state, the information processing apparatus 100 refers to the order management matrix data 540, and determines which one of the number of order of initialization of the first row and the number of order of initialization of the first column is closer to the top side. For example, the information processing apparatus 100 compares an integer value 1604 corresponding to the first column and an integer value 1605 corresponding to the first row in the order management matrix data 540.

Based on the result of comparison, if the number of order of initialization of the first row is closer to the top side, the information processing apparatus 100 refers to the block 610 at the end of the row corresponding to the intersection 1601 in the payload matrix data 510, and reads the row initial value as the data at the intersection 1601. Based on the result of comparison, if the number of order of initialization of the first column is closer to the top side, the information processing apparatus 100 reads the column initial value 1603 corresponding to the intersection 1601 in the column initial value matrix data 530.

Accordingly, the information processing apparatus 100 may appropriately read the data at the intersection 1601 of the first row and the first column. Even in the case where the first row is collectively initialized and the first column is collectively initialized, the information processing apparatus 100 may enable appropriate reading of the data at the intersection 1601 of the first row and the first column in consideration of the order of initialization.

Next, an example in which the information processing apparatus 100 writes data of a component of an array to the payload matrix data 510 in response to a write request will be described with reference to FIG. 17.

FIG. 17 is an explanatory diagram illustrating an example of writing data of a component of an array. In FIG. 17, the information processing apparatus 100 receives a write request that requests writing of a designated value to the data at an intersection 1700 of the first row and the first column in the payload matrix data 510.

The information processing apparatus 100 reads the contents of the block 1701 including the data at the intersection 1700 in the payload matrix data 510. The information processing apparatus 100 writes the designated value to the read contents as the data at the intersection 1700. The information processing apparatus 100 overwrites the block 1701 with the contents to which the designated value has been written. The information processing apparatus 100 sets 1 indicating that data is not in the column initialized state for all flags 1702 of the column bitmap matrix data 520 corresponding to the block 1701.

Accordingly, the information processing apparatus 100 may appropriately write the designated value to the data at the intersection 1700 of the first row and the first column in the payload matrix data 510. By updating the column bitmap matrix data 520, the information processing apparatus 100 may subsequently reduce the cases of erroneous reading of the row initial value or the column initial value as the data at the intersection 1700 of the first row and the first column.

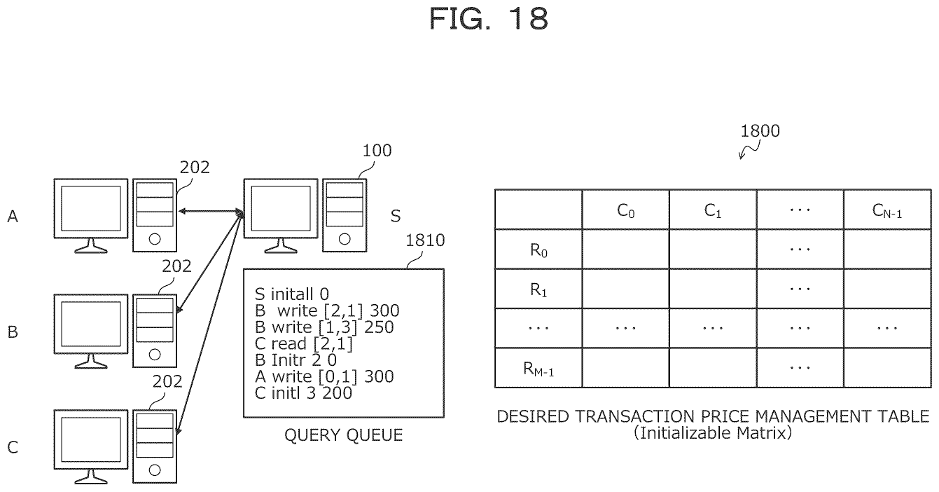

Next, an example of application of the information processing apparatus 100 will be described with reference to FIG. 18.

FIG. 18 is an explanatory diagram illustrating an example of application of the information processing apparatus 100. In FIG. 18, a case will be described in which the information processing apparatus 100 is applied to management of desired transaction prices of N commodities Cⱼ commonly manufactured by M users Rᵢ as illustrated in table 1800. For example, i is 0 to M−1. j is a commodity id. For example, j is 0 to N−1. For example, user Rᵢ has the client apparatus 202. For example, user Rᵢ is a manufacturer of commodities Cⱼ, a vendor of commodities Cⱼ, or the like.

For each user Rᵢ, the information processing apparatus 100 stores, as a row of the payload matrix data 510, an array including the desired transaction prices of N commodities Cⱼ as components. For example, the information processing apparatus 100 stores, as rows of the payload matrix data 510, block strings indicating different arrays including, as components, the desired transaction prices of N commodities Cⱼ for different users Rᵢ. For example, a block includes areas capable of storing 100 components. For example, a block string includes four blocks.

The information processing apparatus 100 sequentially receives various queries indicated in a query queue 1810. For example, the information processing apparatus 100 receives a query from user Rᵢ via the client apparatus 202. For example, the information processing apparatus 100 may receive a query by receiving input of the query via an input device (not illustrated).

For example, a query is an entire initialization request (initall) that requests initialization of the entire payload matrix data 510. initall a indicates that the entire payload matrix data 510 is initialized with the value a. X initall a indicates that an entire initialization request has been received from X. For example, X is the information processing apparatus 100 (S), the client apparatus 202 (A, B, C), or the like.

For example, a query is a row initialization request (initr) that requests initialization of any row of the payload matrix data 510. initr a b indicates that the entire row of the payload matrix data 510 corresponding to the user Rₐ is initialized with the value b. X initr a b indicates that a row initialization request has been received from X.

For example, a query is a column initialization request (initl) that requests initialization of any column of the payload matrix data 510. initl a b indicates that the entire column of the payload matrix data 510 corresponding to commodity id=a is initialized with the value b. X initl a b indicates that a column initialization request has been received from X.

For example, a query is a write request (write) that requests storage of the value of any component in any block string. write [a, b] c indicates that (value of the component of commodity id=b)=c is stored in the row of the payload matrix data 510 corresponding to the user Rₐ. X write [a, b] c indicates that a write request has been received from X.

For example, a query is a read request (read) that requests reading of the value of any component from any block string. read [a, b] indicates that the value of the component of commodity id=b is read from the row of the payload matrix data 510 corresponding to the user Rₐ. X read [a, b] indicates that a read request has been received from X.

The information processing apparatus 100 sequentially processes the various queries indicated in the query queue 1810 as illustrated in FIGS. 13 to 17. Consequently, the information processing apparatus 100 may appropriately process the various queries indicated in the query queue 1810, and may appropriately manage the desired transaction prices of N commodities Cⱼ commonly manufactured by M users Rᵢ.

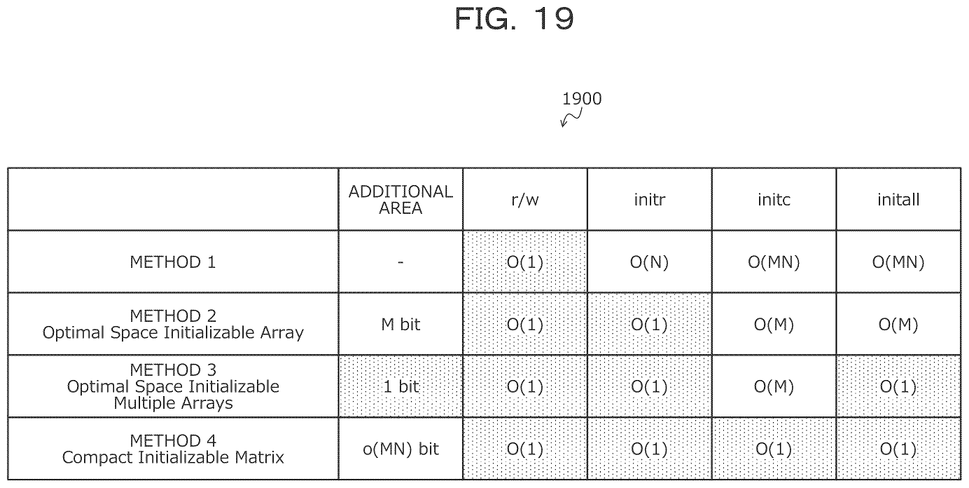

Next, an example of the effect produced by the information processing apparatus 100 will be described with reference to FIG. 19.

FIG. 19 is an explanatory diagram illustrating an example of the effect produced by the information processing apparatus 100. In FIG. 19, description will be given for a result of comparison between the above-described method in which the information processing apparatus 100 manages the payload matrix data 510 and other methods. For example, table 1900 illustrates a result of comparison between method 1 to be described later, method 2 to be described later, method 3 to be described later, and method 4 of the information processing apparatus 100. For example, method 4 is referred to as compact initializable matrix.

For example, method 1 is a method in which a plurality of arrays is represented as matrix format data 1 that does not have a special data structure. For example, the special data structure is OSIA or the like. In method 1, the processing load and processing time taken for writing to or reading from the matrix format data 1 are O (1). In method 1, the processing load and processing time taken for initialization of a row of the matrix format data 1 are O (N). In method 1, the processing load and processing time taken for initialization of a column of the matrix format data 1 are O (MN). In method 1, the processing load and processing time taken for initialization of the entire matrix format data 1 are O (MN).

For example, method 2 is a method in which a plurality of arrays is represented as matrix format data 2 that has the data structure called OSIA. In method 2, the processing load and processing time taken for writing to or reading from the matrix format data 2 are O (1). In method 2, the processing load and processing time taken for initialization of a row of the matrix format data 2 are O (1). In method 2, the processing load and processing time taken for initialization of a column of the matrix format data 2 are O (M). In method 2, the processing load and processing time taken for initialization of the entire matrix format data 2 are O (M). In method 2, the amount of data is increased by M bits as compared with method 1.

For example, method 3 is a method in which a plurality of arrays is represented as matrix format data 3 that has the data structure called initializable multiple arrays illustrated in FIGS. 6 and 7. In method 3, the processing load and processing time taken for writing to or reading from the matrix format data 3 are O (1). In method 3, the processing load and processing time taken for initialization of a row of the matrix format data 3 are O (1). In method 3, the processing load and processing time taken for initialization of a column of the matrix format data 3 are O (M). In method 3, the processing load and processing time taken for initialization of the entire matrix format data 3 are O (1). In method 3, the amount of data is increased by 1 bit as compared with method 1.

By contrast, in method 4, the processing load and processing time taken for writing to or reading from the payload matrix data 510 are O (1). In method 4, the processing load and processing time taken for initialization of a row of the payload matrix data 510 are O (1). In method 4, the processing load and processing time taken for initialization of a column of the payload matrix data 510 are O (1). In method 4, the processing load and processing time taken for initialization of the entire payload matrix data 510 are O (1). In method 4, the amount of data is increased by O (MN) bits as compared with method 1.

As described above, the information processing apparatus 100 may perform writing to or reading from the payload matrix data 510 without causing such a disadvantage that the processing load and processing time taken for the writing or reading increase as compared with the other methods. The information processing apparatus 100 may reduce the processing load and processing time taken for initialization of a row of the payload matrix data 510 to O (1) as compared with method 1. The information processing apparatus 100 may reduce the processing load and processing time taken for initialization of a column of the payload matrix data 510 to O (1) as compared with the other methods. The information processing apparatus 100 may reduce the processing load and processing time taken for initialization of the entire payload matrix data 510 to O (1) as compared with method 1 and method 2.

### (Procedure of Entire Initialization Processing)

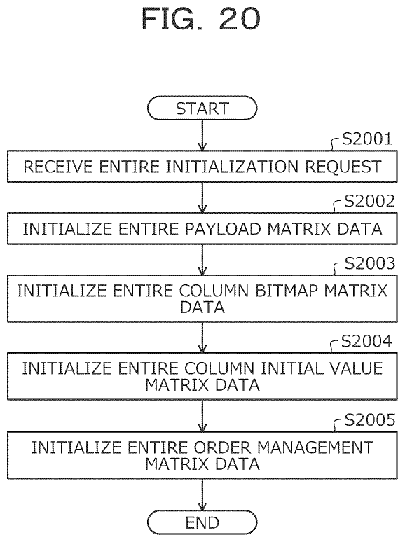

Next, an example of a procedure of entire initialization processing executed by the information processing apparatus 100 will be described with reference to FIG. 20. For example, the entire initialization processing is realized by the CPU 301, the storage area such as the memory 302 or the recording medium 305, and the network I/F 303 illustrated in FIG. 3.

FIG. 20 is a flowchart illustrating an example of the procedure of the entire initialization processing. In FIG. 20, the information processing apparatus 100 receives an entire initialization request that requests initialization of the entire payload matrix data 510 (step S2001).

Next, the information processing apparatus 100 initializes the entire payload matrix data 510 (step S2002). The information processing apparatus 100 initializes the entire column bitmap matrix data 520 (step S2003).

Next, the information processing apparatus 100 initializes the entire column initial value matrix data 530 (step S2004). The information processing apparatus 100 initializes the entire order management matrix data 540 (step S2005). After that, the information processing apparatus 100 ends the entire initialization processing.

### (Procedure of Row Initialization Processing)

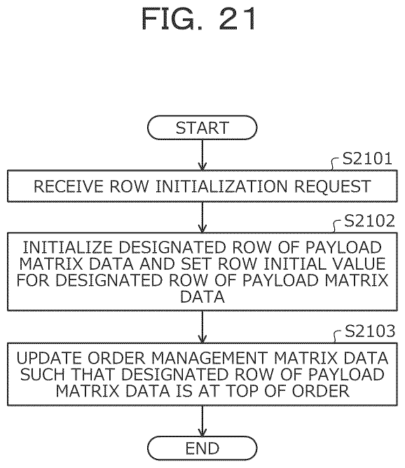

Next, an example of a procedure of row initialization processing executed by the information processing apparatus 100 will be described with reference to FIG. 21. For example, the row initialization processing is realized by the CPU 301, the storage area such as the memory 302 or the recording medium 305, and the network I/F 303 illustrated in FIG. 3.

FIG. 21 is a flowchart illustrating an example of the procedure of the row initialization processing. In FIG. 21, the information processing apparatus 100 receives a row initialization request that requests initialization of a designated row of the payload matrix data 510 (step S2101).

Next, the information processing apparatus 100 initializes the designated row of the payload matrix data 510, and sets a row initial value for the designated row of the payload matrix data 510 (step S2102). The information processing apparatus 100 updates the order management matrix data 540 such that the designated row of the payload matrix data 510 is at the top of the order (step S2103). After that, the information processing apparatus 100 ends the row initialization processing.

### (Procedure of Column Initialization Processing)

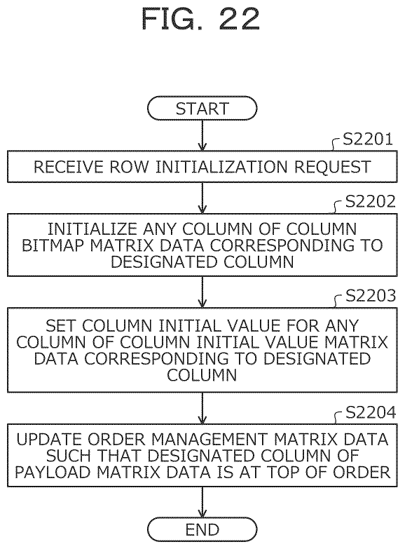

Next, an example of a procedure of column initialization processing executed by the information processing apparatus 100 will be described with reference to FIG. 22. For example, the column initialization processing is realized by the CPU 301, the storage area such as the memory 302 or the recording medium 305, and the network I/F 303 illustrated in FIG. 3.

FIG. 22 is a flowchart illustrating an example of the procedure of the column initialization processing. In FIG. 22, the information processing apparatus 100 receives a column initialization request that requests initialization of a designated column of the payload matrix data 510 (step S2201).

Next, the information processing apparatus 100 initializes any column of the column bitmap matrix data 520 corresponding to the designated column (step S2202). The information processing apparatus 100 sets a column initial value for any column of the column initial value matrix data 530 corresponding to the designated column (step S2203).

Next, the information processing apparatus 100 updates the order management matrix data 540 such that the designated column of the payload matrix data 510 is at the top of the order (step S2204). The information processing apparatus 100 ends the column initialization processing.

### (Procedure of Read Processing)

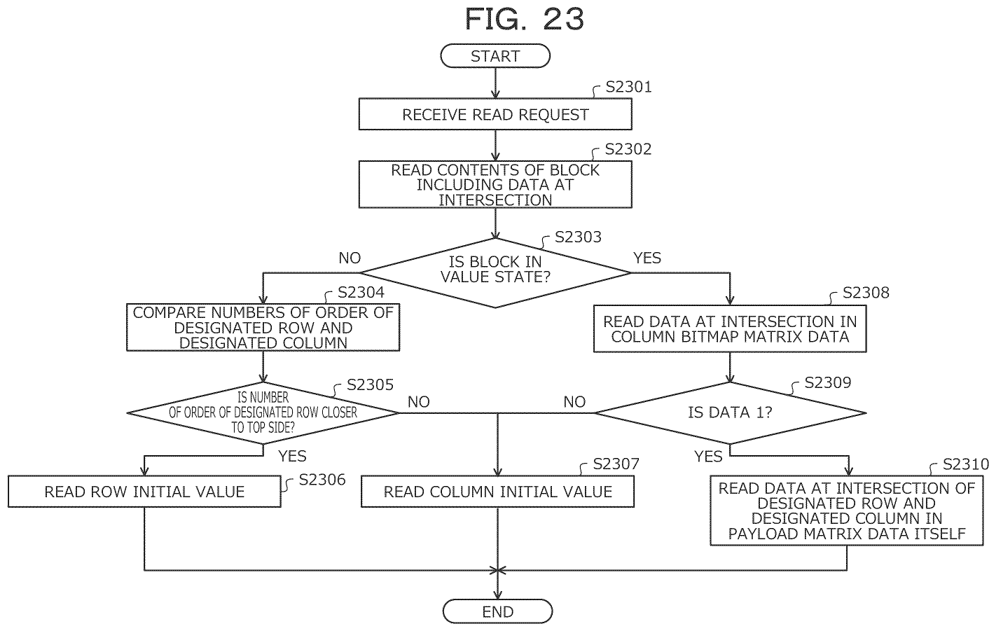

Next, an example of a procedure of read processing executed by the information processing apparatus 100 will be described with reference to FIG. 23. For example, the read processing is realized by the CPU 301, the storage area such as the memory 302 or the recording medium 305, and the network I/F 303 illustrated in FIG. 3.

FIG. 23 is a flowchart illustrating an example of the procedure of the read processing. In FIG. 23, the information processing apparatus 100 receives a read request of data at an intersection of a designated row and a designated column in the payload matrix data 510 (step S2301).

Next, the information processing apparatus 100 identifies a block including the data at the intersection of the designated row and the designated column in the payload matrix data 510, and reads the contents of the block (step S2302). The information processing apparatus 100 determines whether the identified block is in the value state based on the read contents of the block (step S2303). When the identified block is in the value state (step S2303: Yes), the information processing apparatus 100 proceeds to the processing of step S2308. By contrast, when the identified block is not in the value state (step S2303: No), the information processing apparatus 100 proceeds to the processing of step S2304.

In step S2304, the information processing apparatus 100 refers to the order management matrix data 540 and compares the numbers of order of the designated row and the designated column (step S2304). Next, the information processing apparatus 100 determines whether the number of order of the designated row is closer to the top side compared to that of the designated column (step S2305). When the number of order of the designated column is closer to the top side (step S2305: No), the information processing apparatus 100 proceeds to the processing of step S2307. By contrast, when the number of order of the designated row is closer to the top side (step S2305: Yes), the information processing apparatus 100 proceeds to the processing of step S2306.

In step S2306, the information processing apparatus 100 reads a row initial value from the designated row of the payload matrix data 510 as the data at the intersection of the designated row and the designated column (step S2306). The information processing apparatus 100 ends the read processing.

In step S2307, the information processing apparatus 100 reads a column initial value from any column of the column initial value matrix data 530 corresponding to the designated column as the data at the intersection of the designated row and the designated column (step S2307). The information processing apparatus 100 ends the read processing.

In step S2308, the information processing apparatus 100 reads data at an intersection of any row and any column in the column bitmap matrix data 520 corresponding to the intersection of the designated row and the designated column (step S2308). Next, the information processing apparatus 100 determines whether the read data is 1 (step S2309). When the data is not 1 (step S2309: No), the information processing apparatus 100 proceeds to the processing of step S2307. On the other hand, when the data is 1 (step S2309: Yes), the information processing apparatus 100 proceeds to the processing of step S2310.

In step S2310, the information processing apparatus 100 reads the data at the intersection of the designated row and the designated column in the payload matrix data 510 itself (step S2310). The information processing apparatus 100 ends the read processing.

### (Procedure of Write Processing)

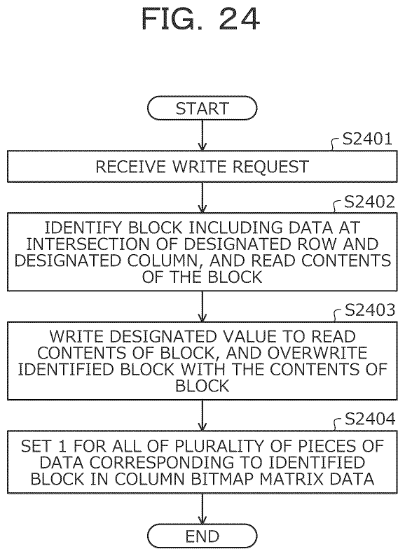

Next, an example of a procedure of write processing executed by the information processing apparatus 100 will be described with reference to FIG. 24. For example, the write processing is realized by the CPU 301, the storage area such as the memory 302 or the recording medium 305, and the network I/F 303 illustrated in FIG. 3.

FIG. 24 is a flowchart illustrating an example of the procedure of the write processing. In FIG. 24, the information processing apparatus 100 receives a write request for writing a designated value to the data at the intersection of the designated row and the designated column in the payload matrix data 510 (step S2401).

Next, the information processing apparatus 100 identifies a block including the data at the intersection of the designated row and the designated column in the payload matrix data 510, and reads the contents of the block (step S2402). The information processing apparatus 100 writes the designated value to the read contents of the block, and overwrites the identified block with the contents of the block (step S2403).

Next, the information processing apparatus 100 sets 1 for all of the plurality of pieces of data corresponding to the identified block in the column bitmap matrix data 520 (step S2404). The information processing apparatus 100 ends the write processing.

The information processing apparatus 100 may execute the processing of the flowcharts of FIGS. 20 to 24 by partly changing the order of the steps in each flowchart. The information processing apparatus 100 may partly omit the processing of the steps in each of the flowcharts of FIGS. 20 to 24. For example, the processing of step S2001 may be omitted.

As described above, according to the information processing apparatus 100, it is possible to store the first matrix data that holds data of components of an array in the row direction. According to the information processing apparatus 100, it is possible to store the second matrix data that holds, in association with each piece of data in the first matrix data, a flag indicating whether the data is in the initialized state in which data is collectively initialized in the column direction. According to the information processing apparatus 100, it is possible to store the third matrix data that includes an area for holding, in association with each column of the first matrix data, an initial value of each piece of data in the column in a case where the plurality of pieces of data in the column is collectively initialized in the column direction. According to the information processing apparatus 100, it is possible to receive a first initialization request for collectively initializing a plurality of pieces of data in the first column of the first matrix data in the column direction. According to the information processing apparatus 100, in response to the reception of the first initialization request, it is possible to set a value indicating the initialized state for the plurality of flags of the second matrix data respectively associated with the plurality of pieces of data in the first column. According to the information processing apparatus 100, in response to the reception of the first initialization request, it is possible to set a first initial value in any area of the third matrix data associated with the first column. Accordingly, the information processing apparatus 100 may enable collective initialization of a column of the first matrix data.

According to the information processing apparatus 100, it is possible to hold, in association with each row of first matrix data, in a predetermined area of the row, an initial value of each piece of data in the row in a case where the plurality of pieces of data in the row is collectively initialized in the row direction. According to the information processing apparatus 100, in response to reception of a second initialization request for collectively initializing a plurality of pieces of data in the first row of the first matrix data in the row direction, it is possible to set a second initial value in a predetermined area of the first row. Accordingly, the information processing apparatus 100 may enable collective initialization of a row of the first matrix data.

According to the information processing apparatus 100, it is possible to store the fourth matrix data representing at least an order relationship between the first column and the first row. According to the information processing apparatus 100, in response to the reception of the first initialization request, it is possible to update the fourth matrix data such that the first column is at the top of the order. According to the information processing apparatus 100, in response to the reception of the second initialization request, it is possible to update the fourth matrix data such that the first row is at the top of the order. According to the information processing apparatus 100, it is possible to receive a read request for reading the data at the intersection of the first column and the first row in the first matrix data. According to the information processing apparatus 100, in response to the reception of the read request, when the first initial value and the second initial value have been set, it is possible to refer to the fourth matrix data and determine whether the number of order of the first column is closer to the top side compared to that of the first row. According to the information processing apparatus 100, it is possible to read the first initial value when the number of order of the first column is closer to the top side compared to that of the first row, and to read the second initial value when the number of order of the first row is closer to the top side compared to that of the first column. Accordingly, the information processing apparatus 100 may appropriately read the value being the data at the intersection in consideration of the order in which the first row and the first column are initialized.

According to the information processing apparatus 100, in response to the reception of the read request, when the first initial value has been set and the second initial value has not been set, it is possible to read the first initial value. According to the information processing apparatus 100, when the first initial value has not been set and the second initial value has been set, it is possible to read the second initial value. According to the information processing apparatus 100, when the first initial value has not been set and the second initial value has not been set, it is possible to read the data at the intersection. Accordingly, the information processing apparatus 100 may appropriately read the value being the data at the intersection.

According to the information processing apparatus 100, it is possible to receive a write request for writing a designated value to the data at the intersection. According to the information processing apparatus 100, in response to the reception of the write request, it is possible to update the first matrix data such that the data at the intersection indicates the designated value. According to the information processing apparatus 100, it is possible to set a value indicating that the data is not in the initialized state for any flag of the second matrix data associated with the data at the intersection. Accordingly, the information processing apparatus 100 may write the designated value to the data at the intersection.

According to the information processing apparatus 100, each row of the first matrix data may be treated as the data structure of optimal space initializable array in the row direction. According to the information processing apparatus 100, each column of the second matrix data may be treated as the data structure of optimal space initializable array in the column direction. Accordingly, the information processing apparatus 100 may make it easier to initialize each row of the first matrix data, and may achieve reduction of the processing load and processing time taken when each row of the first matrix data is initialized. The information processing apparatus 100 may make it easier to initialize each column of the second matrix data, and may achieve reduction of the processing load and processing time taken when each column of the second matrix data is initialized.

The information processing method described in the present embodiment may be implemented by causing a computer, such as a PC or a workstation, to execute a program prepared in advance. The information processing program described in the present embodiment is executed by being recorded on a computer-readable recording medium and read from the recording medium by the computer. The recording medium is a hard disk, a flexible disk, a compact disc (CD)-ROM, a magneto optical (MO) disc, a Digital Versatile Disc (DVD), or the like. The information processing program described in the present embodiment may be distributed via a network, such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute a process comprising:
storing, in a storage, first matrix data that holds data of components of an array in a row direction;
storing, in the storage, second matrix data that holds, in association with each piece of data in the first matrix data, a flag that indicates whether the data is in an initialized state in which data is collectively initialized in a column direction;
storing, in the storage, third matrix data that includes an area that holds, in association with each column of the first matrix data, an initial value common to a plurality of pieces of data in the column which is regarded as an initial value of each piece of data in the column in a case where a plurality of pieces of data in the column is collectively initialized in a column direction;
in response to reception of a first initialization request for collectively initializing a plurality of pieces of data in a first column of the first matrix data in a column direction, setting a value that indicates an initialized state to a plurality of flags of the second matrix data respectively associated with a plurality of pieces of data in the first column; and
in response to reception of the first initialization request, setting a first initial value in any area of the third matrix data associated with the first column.

2. The non-transitory computer-readable recording medium according to claim 1, wherein
the first matrix data is capable of holding, in association with each row of the first matrix data, in a predetermined area of the row, an initial value common to a plurality of pieces of data in the row which is regarded as an initial value of each piece of data in the row in a case where a plurality of pieces of data in the row is collectively initialized in a row direction, and
the computer is caused to execute a process of setting, in response to reception of a second initialization request for collectively initializing a plurality of pieces of data in a first row of the first matrix data in a row direction, a second initial value in a predetermined area of the first row.

3. The non-transitory computer-readable recording medium according to claim 2, wherein
the computer is caused to execute a process including
storing fourth matrix data that represents at least an order relationship between the first column and the first row in the storage,
in response to reception of the first initialization request, updating the fourth matrix data such that the first column is at a top of an order,
in response to reception of the second initialization request, updating the fourth matrix data such that the first row is at a top of an order, and
in response to reception of a read request for reading data at an intersection of the first column and the first row of the first matrix data, when the first initial value and the second initial value have been set, referring to the fourth matrix data and reading the first initial value when a number of order of the first column is closer to a top side compared to that of the first row and reading the second initial value when a number of order of the first row is closer to a top side compared to that of the first column.

4. The non-transitory computer-readable recording medium according to claim 3, wherein
the reading includes
in response to reception of the read request, reading the first initial value when the first initial value has been set and the second initial value has not been set, reading the second initial value when the first initial value has not been set and the second initial value has been set, and reading the data at an intersection when the first initial value has not been set and the second initial value has not been set.

5. The non-transitory computer-readable recording medium according to claim 3, wherein
the computer is caused to execute a process of, in response to reception of a write request for writing a designated value to the data at an intersection, updating the first matrix data such that the data at an intersection indicates the designated value, and setting a value indicating that data is not in an initialized state for any flag of the second matrix data associated with the data at an intersection.

6. The non-transitory computer-readable recording medium according to claim 3, wherein
each row of the first matrix data is treated as a data structure of optimal space initializable array in a row direction, and
each column of the second matrix data is treated as a data structure of optimal space initializable array in a column direction.

7. An information processing method performed by a computer, the method comprising:
storing, in a storage, first matrix data that holds data of components of an array in a row direction;
storing, in the storage, second matrix data that holds, in association with each piece of data in the first matrix data, a flag that indicates whether the data is in an initialized state in which data is collectively initialized in a column direction;
storing, in the storage, third matrix data that includes an area that holds, in association with each column of the first matrix data, an initial value common to a plurality of pieces of data in the column which is regarded as an initial value of each piece of data in the column in a case where a plurality of pieces of data in the column is collectively initialized in a column direction;
in response to reception of a first initialization request for collectively initializing a plurality of pieces of data in a first column of the first matrix data in a column direction, setting a value that indicates an initialized state to a plurality of flags of the second matrix data respectively associated with a plurality of pieces of data in the first column; and
in response to reception of the first initialization request, setting a first initial value in any area of the third matrix data associated with the first column.

8. An information processing apparatus comprising:
a storage, and
a processor coupled to the memory and configured to:
store, in the storage, first matrix data that holds data of components of an array in a row direction;
store, in the storage, second matrix data that holds, in association with each piece of data in the first matrix data, a flag that indicates whether the data is in an initialized state in which data is collectively initialized in a column direction;
store, in the storage, third matrix data that includes an area that holds, in association with each column of the first matrix data, an initial value common to a plurality of pieces of data in the column which is regarded as an initial value of each piece of data in the column in a case where a plurality of pieces of data in the column is collectively initialized in a column direction;
in response to reception of a first initialization request for collectively initializing a plurality of pieces of data in a first column of the first matrix data in a column direction, set a value that indicates an initialized state to a plurality of flags of the second matrix data respectively associated with a plurality of pieces of data in the first column; and
in response to reception of the first initialization request, setting a first initial value in any area of the third matrix data associated with the first column.
